(19) United States
(12) Patent Application Publication
(10) Pub. No.: US 2021/0249911 A1
(43) Pub. Date: Aug. 12, 2021

(54) MODULAR FREE-POSITIONING WIRELESS CHARGING DEVICES

(71) Applicant: AIRA, INC., Chandler, AZ (US)

(72) Inventors: Jake Slatnick, San Diego, CA (US); Eric Heindel Goodchild, Phoenix, AZ (US)

(21) Appl. No.: 17/168,161

(22) Filed: Feb. 4, 2021

Related U.S. Application Data
(60) Provisional application No. 62/971,211, filed on Feb. 6, 2020.
(60) Provisional application No. 63/066,223, filed on Aug. 15, 2020.

(51) Int. Cl. H02J 50/40; H02J 7/02; H02J 50/12; H02J 50/90; H02J 50/80; H02J 7/00

(52) U.S. Cl. CPC H02J 50/402; H02J 7/02; H02J 7/00032; H02J 50/90; H02J 50/80; H02J 50/12

(57) ABSTRACT

Systems, methods and apparatus for wireless charging are disclosed. A method for configuring a charging device includes identifying a first plurality of transmitting coils arranged in a modular pattern on a first printed circuit board, the first plurality of transmitting coils defining a first charging surface, identifying a second plurality of transmitting coils arranged in the modular pattern on a second printed circuit board, the second plurality of transmitting coils defining a second charging surface, determining an alignment of the first printed circuit board with the second printed circuit board, providing a charging current to the first charging surface and the second charging surface, and selecting one or more transmitting coils to receive the charging current. Each of the one or more transmitting coils is provided in the first plurality of transmitting coils or the second plurality of transmitting coils.

### PRIORITY CLAIM

This application claims priority to and the benefit of provisional patent application No. 62/971,211 filed in the United States Patent Office on Feb. 6, 2020 and of provisional patent application No. 63/066,223 filed in the United States Patent Office on Aug. 15, 2020, the entire content of these applications being incorporated herein by reference as if fully set forth below in their entirety and for all applicable purposes.

### TECHNICAL FIELD

The present invention relates generally to charging surfaces for wireless charging of batteries, including batteries in mobile computing devices and more particularly to providing a distributed charging surface comprising modular elements.

### BACKGROUND

Wireless charging systems have been deployed to enable certain types of devices to charge internal batteries without the use of a physical charging connection. Devices that can take advantage of wireless charging include mobile processing and/or communication devices. Standards, such as the Qi standard defined by the Wireless Power Consortium enable devices manufactured by a first supplier to be wirelessly charged using a charger manufactured by a second supplier. Standards for wireless charging are optimized for relatively simple configurations of devices and tend to provide basic charging capabilities.

Improvements in wireless charging capabilities are required to provide flexibility in charging configurations and support continually increasing complexity of mobile devices and changing form factors.

### BRIEF DESCRIPTION OF THE DRAWINGS

FIG. 1 illustrates an example of a charging cell that may be employed to provide a charging surface in accordance with certain aspects disclosed herein.

FIG. 2 illustrates an example of an arrangement of charging cells provided on a single layer of a segment of a charging surface that may be adapted in accordance with certain aspects disclosed herein.

FIG. 3 illustrates an example of an arrangement of charging cells when multiple layers are overlaid within a segment of a charging surface that may be adapted in accordance with certain aspects disclosed herein.

FIG. 4 illustrates the arrangement of power transfer areas provided by a charging surface that employs multiple layers of charging cells configured in accordance with certain aspects disclosed herein.

FIG. 5 illustrates a wireless transmitter that may be provided in a charger base station in accordance with certain aspects disclosed herein.

FIG. 6 illustrates a first topology that supports matrix multiplexed switching for use in a wireless charging device adapted in accordance with certain aspects disclosed herein.

FIG. 7 illustrates a second topology that supports direct current drive in a wireless charging device adapted in accordance with certain aspects disclosed herein.

FIG. 8 illustrates an example of a PCB manufactured in accordance with certain aspects disclosed herein.

FIG. 9 illustrates a first example of a modular charging surface provided in accordance with certain aspects disclosed herein.

FIG. 10 illustrates a second example of a modular charging surface provided in accordance with certain aspects disclosed herein.

FIG. 11 illustrates a third example of a modular charging surface provided in accordance with certain aspects disclosed herein.

FIG. 12 illustrates certain configurations of PCBs that can be used in a modular charging surface provided in accordance with certain aspects disclosed herein.

FIG. 13 illustrates a first example of a field-expandable modular charging surface provided in accordance with certain aspects disclosed herein.

FIG. 14 illustrates a second example of a field-expandable modular charging surface provided in accordance with certain aspects disclosed herein.

FIG. 15 illustrates examples of configurations of control circuits with respect to modular charging devices that are configured in accordance with certain aspects disclosed herein.

FIG. 16 illustrates an example of a modular or physically-distributed charging surface that have charging cell of different sizes in accordance with certain aspects disclosed herein.

FIG. 17 illustrates an example of a charging system that includes multiple charging devices provided in accordance with certain aspects of this disclosure.

FIG. 18 illustrates a first example of a combined control circuit in a modular charging surface provided in accordance with certain aspects disclosed herein.

FIG. 19 illustrates a second example of a combined control circuit that may be provided in a modular charging surface provided according to certain aspects disclosed herein.

FIG. 20 illustrates the use of modular charging devices to provide one or more charging surfaces on an item of furniture in accordance with certain aspects of this disclosure.

FIG. 21 is flowchart illustrating an example of a method for operating a charging system in accordance with certain aspects disclosed herein.

FIG. 22 illustrates one example of an apparatus employing a processing circuit that may be adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of wireless charging systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a processor-readable storage medium. A processor-readable storage medium, which may also be referred to herein as a computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), Near Field Communications (NFC) token, random access memory (RAM), read only memory (ROM), programmable ROM (PROM), erasable PROM (EPROM), electrically erasable PROM (EEPROM), a register, a removable disk, a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

### Overview

Certain aspects of the present disclosure relate to systems, apparatus and methods associated with wireless charging devices that provide a free-positioning charging surface using multiple transmitting coils or that can concurrently charge multiple receiving devices. In one aspect, a controller in the wireless charging device can locate a device to be charged and can configure one or more transmitting coils optimally positioned to deliver power to the receiving device. Charging cells may be provisioned or configured with one or more inductive transmitting coils and multiple charging cells may be arranged or configured to provide the charging surface. The location of a device to be charged may be detected through sensing techniques that associate location of the device to changes in a physical characteristic centered at a known location on the charging surface. In some examples, sensing of location may be implemented using capacitive, resistive, inductive, touch, pressure, load, strain, and/or another appropriate type of sensing.

Certain aspects disclosed herein relate to improved wireless charging systems. Systems, apparatus and methods are disclosed that accommodate free placement of chargeable devices on one or more surfaces provided by a charging system constructed from modular surface elements. In one example, a single surface provided by the charging system is formed from a configuration of multiple modular multi-coil wireless charging elements. In another example, a distributed charging surface may be provided by the charging system using multiple interconnected multi-coil wireless charging elements.

Certain aspects can improve the efficiency and capacity of a wireless power transmission to a receiving device. In one example, a wireless charging device has a battery charging power source, a plurality of charging cells configured in a matrix, a first plurality of switches in which each switch is configured to couple a row of coils in the matrix to a first terminal of the battery charging power source, and a second plurality of switches in which each switch is configured to couple a column of coils in the matrix to a second terminal of the battery charging power source. Each charging cell in the plurality of charging cells may include one or more coils surrounding a power transfer area. The plurality of charging cells may be arranged adjacent to a charging surface without overlap of power transfer areas of the charging cells in the plurality of charging cells.

Certain aspects of the present disclosure relate to systems, apparatus and methods for a wireless charging system that provide multiple power transmitting coils in elements of a modular or distributed surface. The coils may be stacked and can be used to charge target devices presented to the wireless charging systems without a requirement to match a particular geometry or location within a charging surface of the charging device. Each coil may have a shape that is substantially polygonal. In one example, each coil may have a hexagonal shape. Each coil may be implemented using wires, printed circuit board traces and/or other connectors that are provided in a spiral. Each coil may span two or more layers separated by an insulator or substrate such that coils in different layers are centered around a common axis.

According to certain aspects disclosed herein, devices placed on a charging surface provided by the wireless charging system may receive power that is wirelessly transmitted through one or more of the charging cells that are associated with the charging surface. Power can be wirelessly transferred to a receiving device located anywhere on the charging surface. The receiving device can have an arbitrarily defined size and/or shape and may be placed without regard to any discrete placement locations enabled for charging. Multiple devices can be simultaneously or concurrently charged on a single surface. The apparatus can track motion of one or more devices across the surface. A charging system may provide multiple charging surface portions that are physically separated from one another but managed as a single modular charging surface that can manage and control simultaneously charging of multiple devices. The charging system may be manufactured using printed circuit board technology, at low cost and/or with a compact design.

Another aspect of the present disclosure relates to systems, apparatus and methods related to a charging device has a first plurality of transmitting coils arranged in a pattern on a first printed circuit board, the first plurality of transmitting coils defining a first charging surface, a second plurality of transmitting coils arranged in the pattern on a second printed circuit board, the second plurality of transmitting coils defining a second charging surface, a fastening device configured to fasten the first printed circuit board in alignment with the second printed circuit board such that the pattern is continued from the first charging surface into the second charging surface, an electrical interconnect configured to conduct a charging current from the first charging surface into the second charging surface, and a processor configured to select one or more transmitting coils to receive the charging current. Each of the one or more transmitting coils is provided in the first plurality of transmitting coils or the second plurality of transmitting coils.

### Charging Cells

Certain aspects of the present disclosure relate to systems, apparatus and methods applicable to wireless charging devices that provide a free-positioning charging surface that has multiple transmitting coils or that can concurrently charge multiple receiving devices. In one aspect, a processing circuit coupled to the free-positioning charging surface can be configured to locate a device to be charged and can select and configure one or more power transmitting coils that are optimally positioned to deliver power to the receiving device. Charging cells may be configured with one or more inductive transmitting coils and multiple charging cells may be arranged or configured to provide the charging surface. The location of a device to be charged may be detected through sensing techniques that associate location of the device to changes in a physical characteristic centered at a known location on the charging surface. In some examples, sensing of location may be implemented using capacitive, resistive, inductive, touch, pressure, load, strain, and/or another appropriate type of sensing.

According to certain aspects disclosed herein, a charging surface in a wireless charging device may be provided using charging cells that are deployed adjacent to a surface of the charging device. In one example the charging cells are deployed in accordance with a honeycomb packaging configuration. A charging cell may be implemented using one or more coils that can each induce a magnetic field along an axis that is substantially orthogonal to the charging surface. In this disclosure, a charging cell may refer to an element having one or more coils where each coil is configured to produce an electromagnetic field that is additive with respect to the fields produced by other coils in the charging cell and directed along or proximate to a common axis. In this description, a coil in a charging cell may be referred to as a charging coil or a transmitting coil.

In some examples, a charging cell includes coils that are stacked along a common axis. One or more coils may overlap such that they contribute to an induced magnetic field substantially orthogonal to the charging surface. In some examples, a charging cell includes coils that are arranged within a defined portion of the charging surface and that contribute to an induced magnetic field within the defined portion of the charging surface, the magnetic field contributing to a magnetic flux flowing substantially orthogonal to the charging surface. In some implementations, charging cells may be configurable by providing an activating current to coils that are included in a dynamically-defined charging cell. For example, a wireless charging device may include multiple stacks of coils deployed across a charging surface, and the wireless charging device may detect the location of a device to be charged and may select some combination of stacks of coils to provide a charging cell adjacent to the device to be charged. In some instances, a charging cell may include, or be characterized as a single coil. However, it should be appreciated that a charging cell may include multiple stacked coils and/or multiple adjacent coils or stacks of coils.

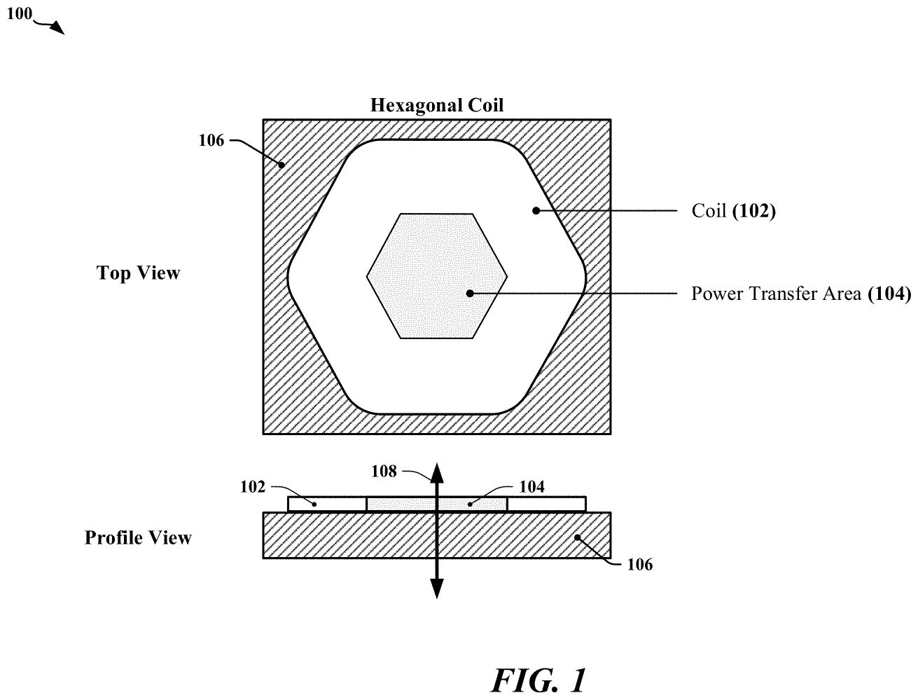

FIG. 1 illustrates an example of a charging cell 100 that may be deployed and/or configured to provide a charging surface in a wireless charging device. In this example, the charging cell 100 has a substantially hexagonal shape that encloses one or more coils 102 constructed using conductors, wires or circuit board traces that can receive a current sufficient to produce an electromagnetic field in a power transfer area 104. In various implementations, some coils 102 may have a shape that is substantially polygonal, including the hexagonal charging cell 100 illustrated in FIG. 1. Other implementations may include or use coils 102 that have other shapes. The shape of the coils 102 may be determined at least in part by the capabilities or limitations of fabrication technology or to optimize layout of the charging cells on a substrate 106 such as a printed circuit board substrate. Each coil 102 may be implemented using wires, printed circuit board traces and/or other connectors in a spiral configuration. Each charging cell 100 may span two or more layers separated by an insulator or substrate 106 such that coils 102 in different layers are centered around a common axis 108.

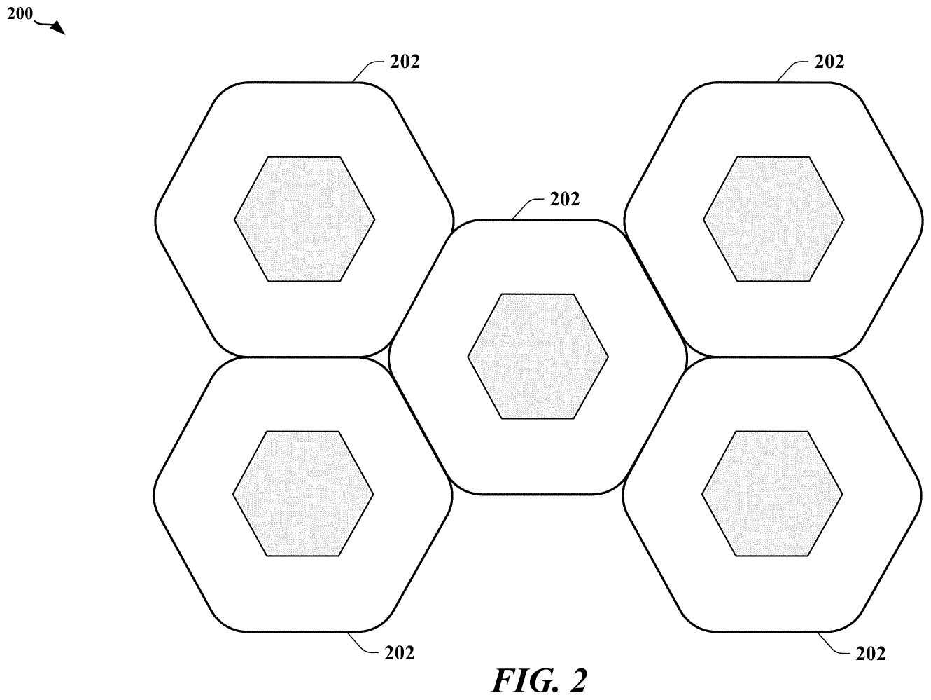

FIG. 2 illustrates an example of an arrangement 200 of charging cells 202 provided on a single layer of a segment or portion of a charging surface that may be adapted in accordance with certain aspects disclosed herein. The charging cells 202 are arranged according to a honeycomb packaging configuration. In this example, the charging cells 202 are arranged end-to-end without overlap. This arrangement can be provided without through-holes or wire interconnects. Other arrangements are possible, including arrangements in which some portion of the charging cells 202 overlap. For example, wires of two or more coils may be interleaved to some extent.

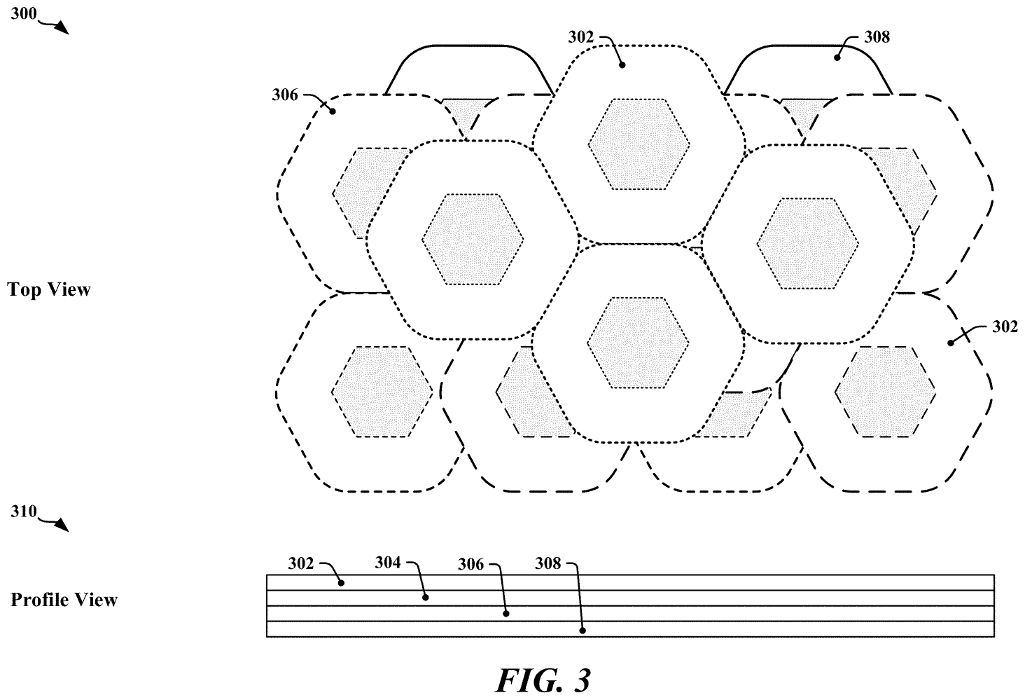

FIG. 3 illustrates an example of an arrangement of charging cells from two perspectives 300, 310 when multiple layers are overlaid within a segment or portion of a charging surface that may be adapted in accordance with certain aspects disclosed herein. Layers of charging cells 302, 304, 306, 308 are provided within the charging surface. The charging cells within each layer of charging cells 302, 304, 306, 308 are arranged according to a honeycomb packaging configuration. In one example, the layers of charging cells 302, 304, 306, 308 may be formed on a printed circuit board that has four or more layers. The arrangement of charging cells 100 can be selected to provide complete coverage of a designated charging area that is adjacent to the illustrated segment.

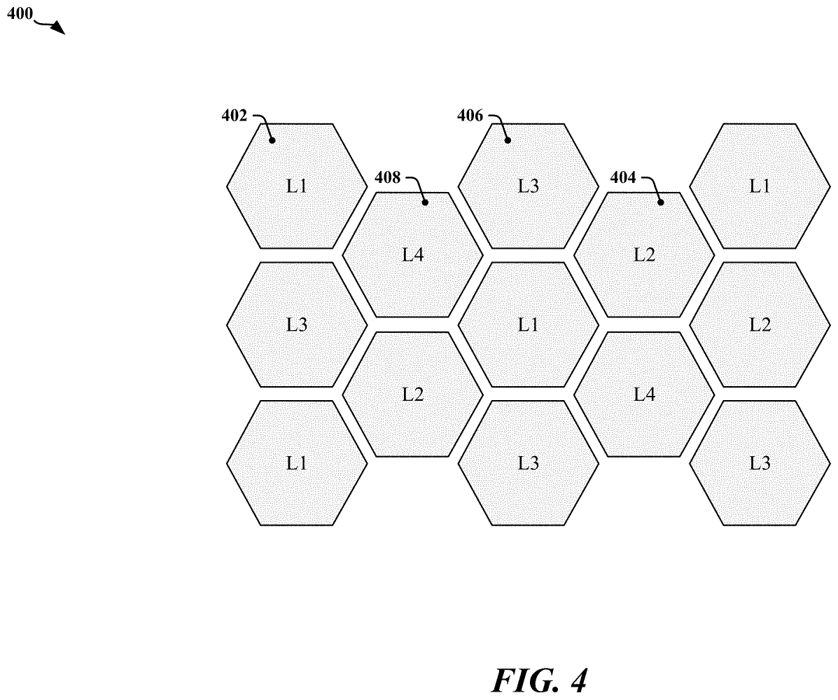

FIG. 4 illustrates the arrangement of power transfer areas provided across a charging surface 400 of a charging device that employs multiple layers of charging cells configured in accordance with certain aspects disclosed herein. The charging device may be constructed from four layers of charging cells 402, 404, 406, 408. In FIG. 4, each power transfer area provided by a charging cell in the first layer of charging cells 402 is marked “L1”, each power transfer area provided by a charging cell in the second layer of charging cells 404 is marked “L2”, each power transfer area provided by a charging cell in the third layer of charging cells 406 is marked “L3”, and each power transfer area provided by a charging cell in the fourth layer of charging cells 408 is marked “L4”.

In accordance with certain aspects disclosed herein, location sensing may rely on changes in some property of the electrical conductors that form coils in a charging cell. Measurable differences in properties of the electrical conductors may include capacitance, resistance, inductance and/or temperature. In some examples, loading of the charging surface can affect the measurable resistance of a coil located near the point of loading. In some implementations, sensors may be provided to enable location sensing through detection of changes in touch, pressure, load and/or strain. Certain aspects disclosed herein provide apparatus and methods that can sense the location of devices that may be freely placed on a charging surface using low-power differential capacitive sense techniques.

### Wireless Transmitter

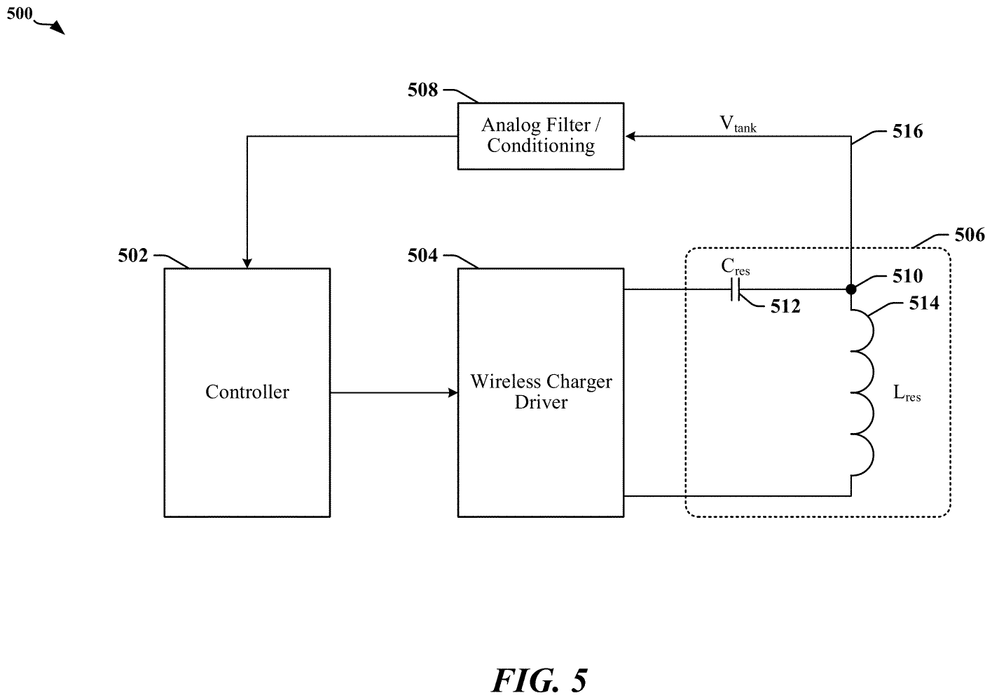

FIG. 5 illustrates an example of a wireless transmitter 500 that can be provided in a base station of a wireless charging device. A base station in a wireless charging device may include one or more processing circuits used to control operations of the wireless charging device. A controller 502 may receive a feedback signal filtered or otherwise processed by a filter circuit 508. The controller may control the operation of a driver circuit 504 that provides an alternating current to a resonant circuit 506. In some examples, the controller 502 may generate a digital frequency reference signal used to control the frequency of the alternating current output by the driver circuit 504. In some instances, the digital frequency reference signal may be generated using a programmable counter or the like. In some examples, the driver circuit 504 includes a power inverter circuit and one or more power amplifiers that cooperate to generate the alternating current from a direct current source or input. In some examples, the digital frequency reference signal may be generated by the driver circuit 504 or by another circuit. The resonant circuit 506 includes a capacitor 512 and inductor 514. The inductor 514 may represent or include one or more transmitting coils in a charging cell that produced a magnetic flux responsive to the alternating current. The resonant circuit 506 may also be referred to herein as a tank circuit, LC tank circuit, or LC tank, and the voltage 516 measured at an LC node 510 of the resonant circuit 506 may be referred to as the tank voltage.

Passive ping techniques may use the voltage and/or current measured or observed at the LC node 510 to identify the presence of a receiving coil in proximity to the charging pad of a device adapted in accordance with certain aspects disclosed herein. Some conventional wireless charging devices include circuits that measure voltage at the LC node 510 of the resonant circuit 506 or the current in the resonant circuit 506. These voltages and currents may be monitored for power regulation purposes and/or to support communication between devices. According to certain aspects of this disclosure, voltage at the LC node 510 in the wireless transmitter 500 illustrated in FIG. 5 may be monitored to support passive ping techniques that can detect presence of a chargeable device or other object based on response of the resonant circuit 506 to a short burst of energy (the ping) transmitted through the resonant circuit 506.

A passive ping discovery technique may be used to provide fast, low-power discovery. A passive ping may be produced by driving a network that includes the resonant circuit 506 with a fast pulse that includes a small amount of energy. The fast pulse excites the resonant circuit 506 and causes the network to oscillate at its natural resonant frequency until the injected energy decays and is dissipated. The response of a resonant circuit 506 to a fast pulse may be determined in part by the resonant frequency of the resonant LC circuit. A response of the resonant circuit 506 to a passive ping that has initial voltage=V₀ may be represented by the voltage VLC observed at the LC node 510, such that:

$${V}_{L C} = {V}_{0} {e}^{- ( \frac{ω}{2 Q} ) t} \qquad ( Eq . 1 )$$

The resonant circuit 506 may be monitored when the controller 502 or another processor is using digital pings to detect presence of objects. A digital ping is produced by driving the resonant circuit 506 for a period of time. The resonant circuit 506 is a tuned network that includes a transmitting coil of the wireless charging device. A receiving device may modulate the voltage or current observed in the resonant circuit 506 by modifying the impedance presented by its power receiving circuit in accordance with signaling state of a modulating signal. The controller 502 or other processor then waits for a data modulated response that indicates that a receiving device is nearby.

### Selectively Activating Coils

According to certain aspects disclosed herein, power transmitting coils in one or more charging cells may be selectively activated to provide an optimal electromagnetic field for charging a compatible device. In some instances, power transmitting coils may be assigned to charging cells, and some charging cells may overlap other charging cells. The optimal charging configuration may be selected at the charging cell level. In some examples, a charging configuration may include charging cells in a charging surface that are determined to be aligned with or located close to the device to be charged. A controller may activate a single power transmitting coil or a combination of power transmitting coils based on the charging configuration which in turn is based on detection of location of the device to be charged. In some implementations, a wireless charging device may have a driver circuit that can selectively activate one or more power transmitting coils or one or more predefined charging cells during a charging event.

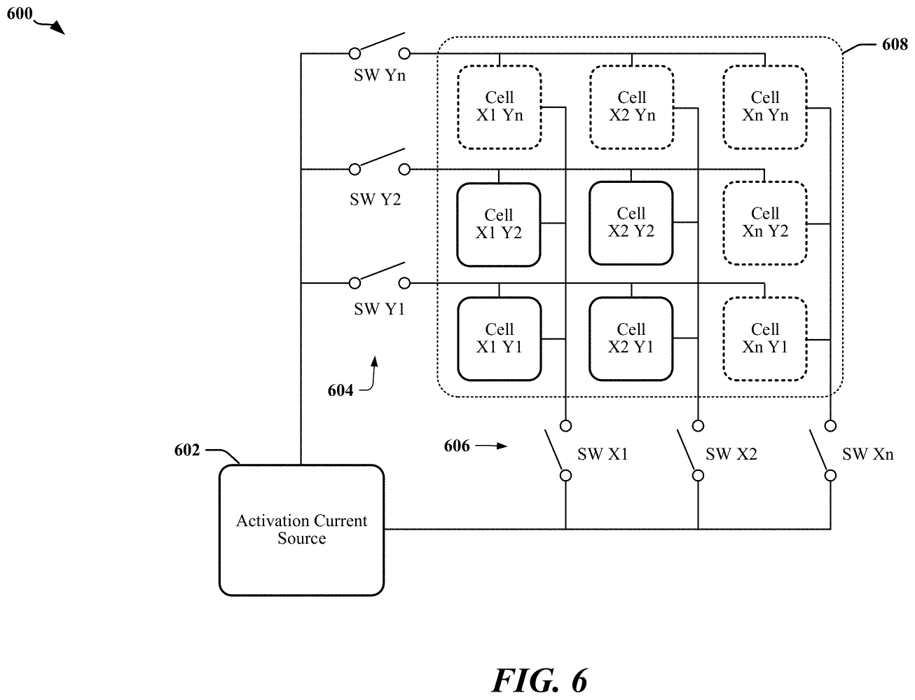

FIG. 6 illustrates a first topology 600 that supports matrix multiplexed switching for use in a wireless charging device adapted in accordance with certain aspects disclosed herein. The wireless charging device may select one or more charging cells 100 to charge a receiving device. Charging cells 100 that are not in use can be disconnected from current flow. A relatively large number of charging cells 100 may be used in the honeycomb packaging configuration illustrated in FIGS. 2 and 3, requiring a corresponding number of switches. According to certain aspects disclosed herein, the charging cells 100 may be logically arranged in a matrix 608 having multiple cells connected to two or more switches that enable specific cells to be powered. In the illustrated topology 600, a two-dimensional matrix 608 is provided, where the dimensions may be represented by X and Y coordinates. Each of a first set of switches 606 is configured to selectively couple a first terminal of each cell in a column of cells to a first terminal of a voltage or current source 602 that provides current to activate coils in one or more charging cells during wireless charging. Each of a second set of switches 604 is configured to selectively couple a second terminal of each cell in a row of cells to a second terminal of the voltage or current source 602. A charging cell is active when both terminals of the cell are coupled to the voltage or current source 602.

The use of a matrix 608 can significantly reduce the number of switching components needed to operate a network of tuned LC circuits. For example, N individually connected cells require at least N switches, whereas a two-dimensional matrix 608 having N cells can be operated with √N switches. The use of a matrix 608 can produce significant cost savings and reduce circuit and/or layout complexity. In one example, a 9-cell implementation can be implemented in a 3×3 matrix 608 using 6 switches, saving 3 switches. In another example, a 16-cell implementation can be implemented in a 4×4 matrix 608 using 8 switches, saving 8 switches.

During operation, at least 2 switches are closed to actively couple one coil or charging cell to the voltage or current source 602. Multiple switches can be closed at once in order to facilitate connection of multiple coils or charging cells to the voltage or current source 602. Multiple switches may be closed, for example, to enable modes of operation that drive multiple transmitting coils when transferring power to a receiving device.

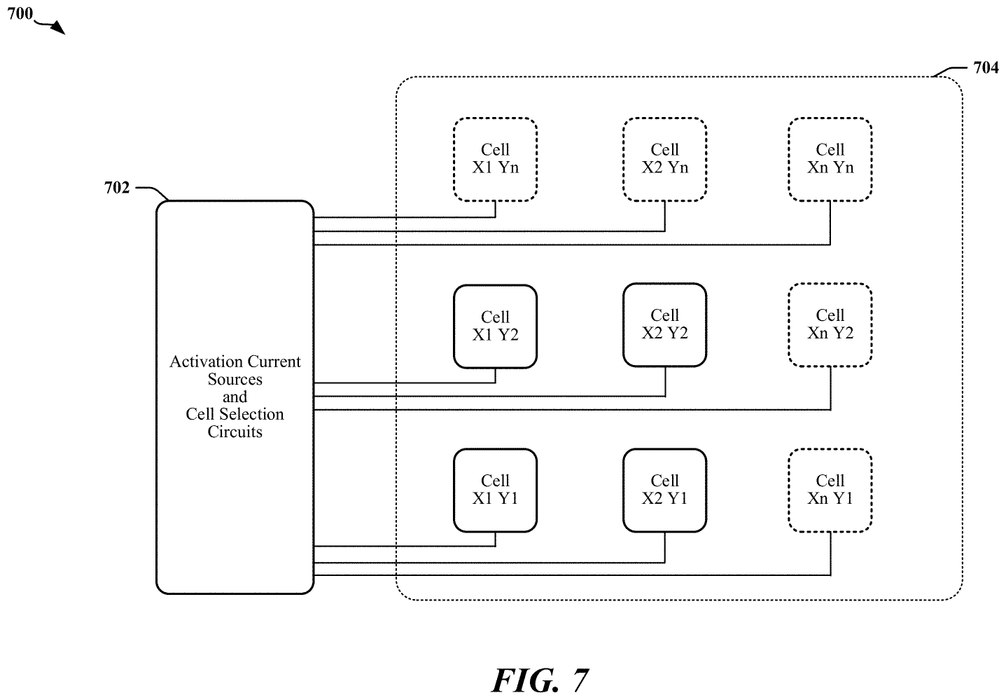

FIG. 7 illustrates a second topology 700 in which each individual coil or charging cell is directly driven by a driver circuit 702 in accordance with certain aspects disclosed herein. The driver circuit 702 may be configured to select one or more coils or charging cells 100 from a group of coils 704 to charge a receiving device. It will be appreciated that the concepts disclosed here in relation to charging cells 100 may be applied to selective activation of individual coils or stacks of coils. Charging cells 100 that are not in use receive no current flow. A relatively large number of charging cells 100 may be in use and a switching matrix may be employed to drive individual coils or groups of coils. In one example, a first switching matrix may configure connections that define a charging cell or group of coils to be used during a charging event and a second switching matrix may be used to activate the charging cell and/or group of selected coils.

### Modular Wireless Charging Surfaces

According to certain aspects of this disclosure, a charging surface provided in wireless charging system may be implemented using a modular PCB system in which each modular PCB carries one or more charging coils arranged in substantially parallel alignment with the charging surface. According to one aspect, the charging system may include multiple modular PCBs configured to provide a large surface area on which a chargeable device can be placed for charging and which can be controlled, managed or drive by a single controlling system. In one example, the modular PCBs may be physically coupled, joined or otherwise provided in a side-by-side or end-on-end configuration to provide a combined charging surface with a desired length, breadth or surface area. In another example, two or more of the modular PCBs may be physically separated and may provide multiple charging surfaces within a room or cabin of a vehicle or in different locations of an item of furniture, such as a desk. The charging system may include modular PCBs that have the same charging coil configuration, including same size and layout of charging coils. In some examples, the charging system includes different types of modular PCBs, including modular PCBs with different layouts, differently-sized charging coils and/or different PCB size. In some examples, a modular PCB may include charging coils of different sizes. In some examples, a modular PCB may include charging coils of different shapes. In some examples, some modular PCBs may be made from a flexible PCB while other modular PCBs may be made from inflexible materials.

In some examples, a modular PCB may be manufactured on printed circuit boards that have 4 or more layers and the charging coils may include coil portions on one or more surfaces of each layer. In conventional systems, it can be advantageous to have an interconnect that passes through some layers but not all layers of the board in printed circuit board designs employing more than 2 layers. Blind vias penetrate a surface on only one side of the PCB, while buried vias connect internal layers without penetrating either surface of the PCB. The use of blind and buried vias can allow higher density packing of circuits onto a PCB. However, the use of blind and buried vias requires additional process steps in PCB production, that can increase cost and time of manufacturing substantially. According to certain aspects disclosed herein, blind and buried vias can be implemented using standard low-cost PCB manufacturing techniques using through holes/vias without increased time and/or cost associated with PCB manufacture and assembly. In some instances, multiple standard-technology, low-cost PCBs may be joined to form a laminate using an adhesive or other mechanical means to bond boards together to form a single larger multilayer board. Interconnections can be made by pressing in pins or soldering a bus connection between the boards.

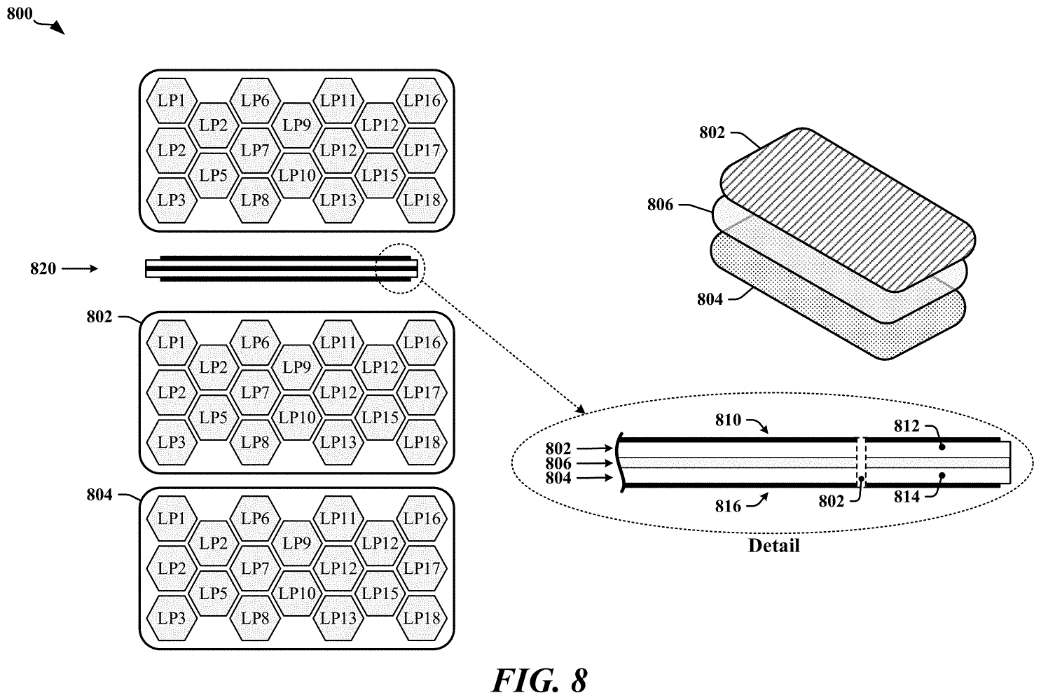

FIG. 8 illustrates a first example of a wireless charging device 800 that provides a charging surface in accordance with certain aspects disclosed herein. A profile view of the wireless charging device 800 is shown at 820. In some examples, multiple copies of the same printed circuit board 802, 804 may be laminated to obtain a final module. In some instances, one or more printed circuit boards 802, 804 can be mirrored, and layered as mirrored versions to form a single assembly with one or more printed circuit boards 802, 804 that have not been mirrored. In the illustrated wireless charging device 800, two 2-layer printed circuit boards 802, 804 of the same design are glued or otherwise joined together. In other examples, more than two printed circuit boards 802, 804 may be layered to form the wireless charging device 800. The printed circuit boards 802, 804 may have different layers, designs, thicknesses, etc. In some examples, magnetic or shielding material may be provided within or with the adhesive layer 806 provided between printed circuit boards 802, 804 to facilitate on-board inductor operation, to shield circuits from EMI and/or for other purposes. Magnetic or shielding material cannot easily be inserted between printed circuit boards 802, 804 that form layers of the wireless charging device 800, where the printed circuit boards 802, 804 are obtained using conventional manufacturing techniques.

In some examples, a charging surface may be provided using two or more printed circuit boards 802, 804. A first printed circuit board 802 has a top layer 810 and a bottom layer 812. The top layer 810 and the bottom layer 812 may be metal, and/or insulated metal. The charging surface includes a second printed circuit board 804 having a top layer 814 and a bottom layer 816. The top layer 814 and the bottom layer 816 may be metal, and/or insulated metal. The charging surface includes an adhesive layer 806 joining the first printed circuit board 802 and the second printed circuit board 804 such that the bottom layer 812 of the first printed circuit board 802 is adjacent to the top layer 814 of the second printed circuit board 804. The charging surface may also include one or more interconnects provided between the bottom layer 812 of the first printed circuit board 802 and the top layer 814 of the second printed circuit board 804. In one example, at least one interconnect does not penetrate the top layer 810 of the first printed circuit board 802. One or more interconnects may not penetrate the bottom layer 816 of the second printed circuit board 804. The adhesive layer 806 may include openings through which at least one interconnect passes between the first printed circuit board 802 and the second printed circuit board 804.

According to certain aspects disclosed herein, a modular charging surface may be assembled by physically joining, coupling or otherwise physically interconnecting multiple PCB modules. In some examples, the modular charging surface is assembled from multiple PCBs that have the same shape and size and that provide the same number and configuration of charging coils. In some examples, the modular charging surface is assembled from multiple PCBs that can have different shapes or sizes and/or that provide different numbers or configurations of charging coils.

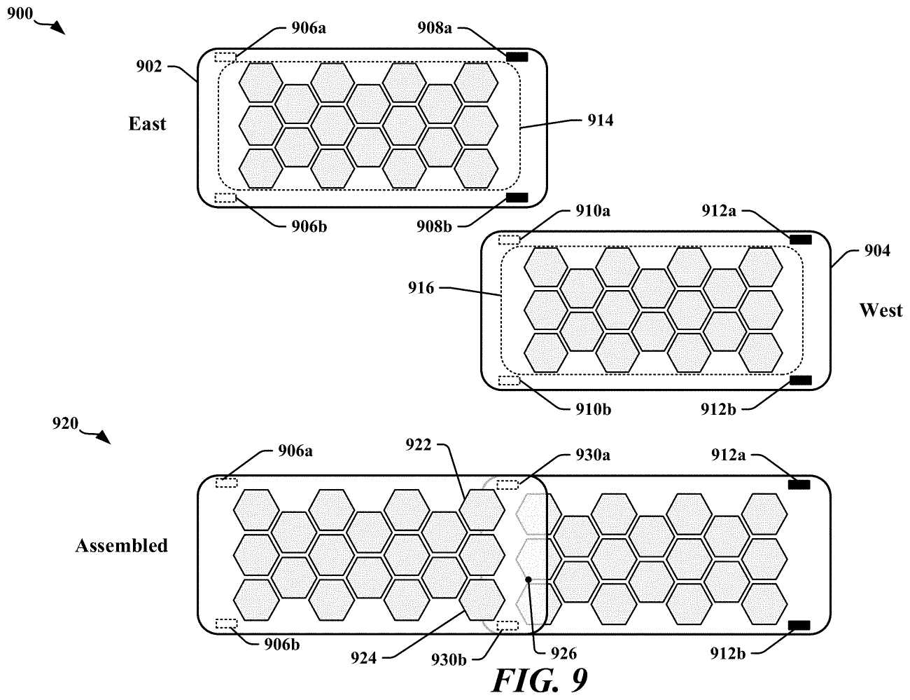

FIG. 9 illustrates a first example of a modular charging surface operated by a wireless charging system that is provided in accordance with certain aspects disclosed herein. The modular charging surface is constructed from two interconnected PCBs 902, 904. As illustrated in the pre-assembly view 900, the PCBs 902, 904 have a common size and shape, and a group of transmitting coils disposed across a charging surface provided by each PCB 902, 904. In this example, the PCBs 902, 904 are configured to be overlaid in one direction, which may be referred to herein as an East-West direction. PCBs 902, 904 may be overlaid to create a charging surface that is an integer N times the width of the area 914, 916 of a PCB 902, 904 that defines the outline of the transmitting coils. The illustrated assembled view 920 provides an example in which N=2, and where an East-side PCB 902 overlays a West-side PCB 904. The transmitting coils (e.g. transmitting cols 922, 924, 926) of the PCBs 902, 904 are arranged in a pattern that continues uninterrupted when the PCBs 902, 904 are overlaid.

In the illustrated example, each PCB 902, 904 has underside connector areas 906a, 906b, 910a, 910b and topside connector areas 908a, 908b, 912a, 912b that are positioned to overlap 930a, 930b when the PCBs 902, 904 are overlaid. Mechanical fasteners may be located in the underside connector areas 906a, 906b, 910a, 910b and topside connector areas 908a, 908b, 912a, 912b. Mechanical fasteners may include bonding points, screws, or other devices that can fasten and/or hold the PCBs 902, 904 in place when overlaid. Electrical connectors may be located in the underside connector areas 906a, 906b, 910a, 910b and topside connector areas 908a, 908b, 912a, 912b. The electrical connectors may conduct data communication links and/or charging currents between the PCBs 902, 904 enabling a controller to configure and operate groups of transmitting coils when charging a receiving device placed on or near the charging surface.

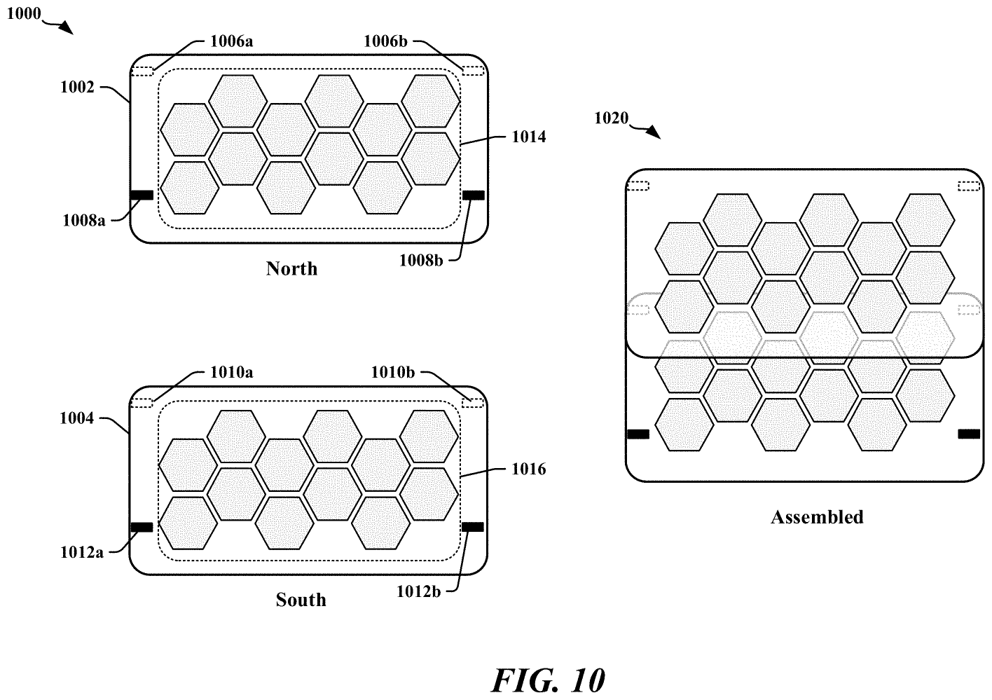

FIG. 10 illustrates a second example of a modular charging surface operated by a wireless charging system that is provided in accordance with certain aspects disclosed herein. The modular charging surface is constructed from two interconnected PCBs 1002, 1004. As illustrated in the pre-assembly view 1000, the PCBs 1002, 1004 have a common size and shape, and a group of transmitting coils disposed across a charging surface provided by each PCB 1002, 1004. In this example, the PCBs 1002, 1004 are configured to be overlaid in either direction and are overlaid in a North-South direction in the illustrated configuration. The PCBs 1002, 1004 may be overlaid to create a charging surface that is an integer N times the width of the area 1014, 1016 of a PCB 1002, 1004 that defines the outline of the transmitting coils. The illustrated assembled view 1020 provides an example in which N=2, and where a North-side PCB 1002 overlays a South-side PCB 1004. The transmitting coils of the PCBs 1002, 1004 are arranged in a pattern that continues uninterrupted when the PCBs 1002, 1004 are overlaid.

In the illustrated example, each PCB 1002, 1004 has underside connector areas 1006a, 1006b, 1010a, 1010b and topside connector areas 1008a, 1008b, 1012a, 1012b that are positioned to overlap when the PCBs 1002, 1004 are overlaid. Mechanical fasteners may be located in the underside connector areas 1006a, 1006b, 1010a, 1010b and topside connector areas 1008a, 1008b, 1012a, 1012b. Mechanical fasteners may include bonding points, screws, or other devices that can fasten and/or hold the PCBs 1002, 1004 in place when overlaid. Electrical connectors may be located in the underside connector areas 1006a, 1006b, 1010a, 1010b and topside connector areas 1008a, 1008b, 1012a, 1012b. The electrical connectors may conduct data communication links and/or charging currents between the PCBs 1002, 1004 enabling a controller to configure and operate groups of transmitting coils when charging a receiving device placed on or near the charging surface.

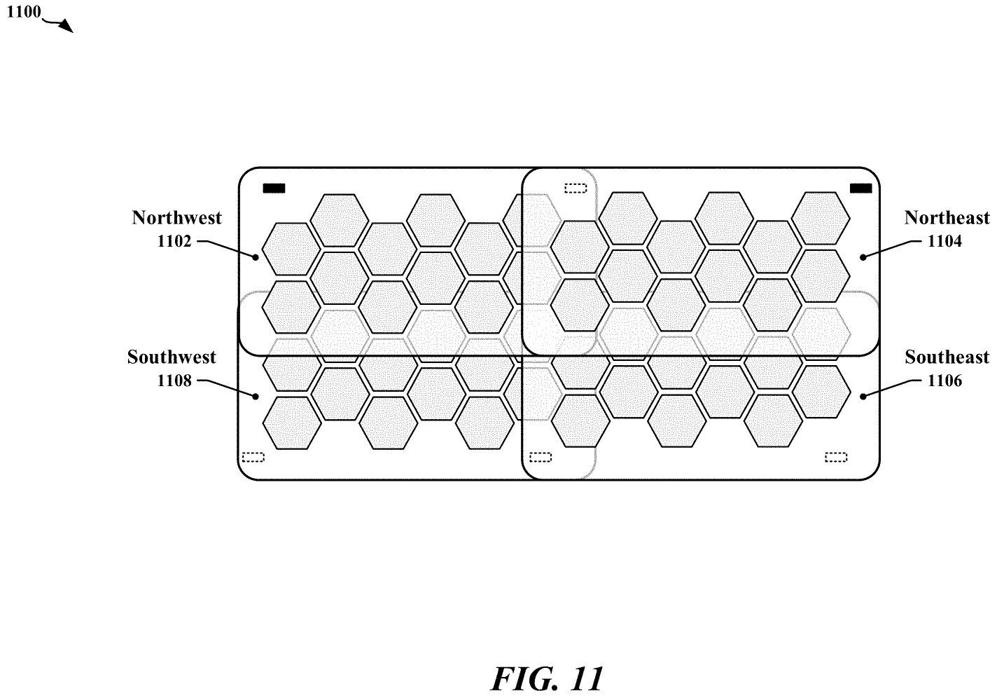

FIG. 11 illustrates a third example of a modular charging surface 1100 operated by a wireless charging system that is provided in accordance with certain aspects disclosed herein. The modular charging surface 1100 is constructed from four interconnected PCBs 1102, 1104, 1106, 1108. The PCBs 1102, 1104, 1106, 1108 have a common size and shape, and a group of transmitting coils disposed across a charging surface provided by each PCB 1102, 1104, 1106, 1108. In this example, the PCBs 1102, 1104, 1106, 1108 are configured to be overlaid in either direction. The PCBs 1102, 1104, 1106, 1108 may be overlaid to create a charging surface that is an integer M×N times the width of the area of a PCB 1102, 1104, 1106, 1108 that defines the outline of the transmitting coils. In the illustrated modular charging surface 1100, M=2 and N=2. The transmitting coils of the PCBs 1102, 1104, 1106, 1108 are arranged in a pattern that continues uninterrupted when the PCBs 1102, 1104, 1106, 1108 are overlaid. In some examples, PCBs 1102, 1104, 1106, 1108 can be interconnected in other to form a modular charging surface that is shaped as a cross, a “T” or that has an irregular shape.

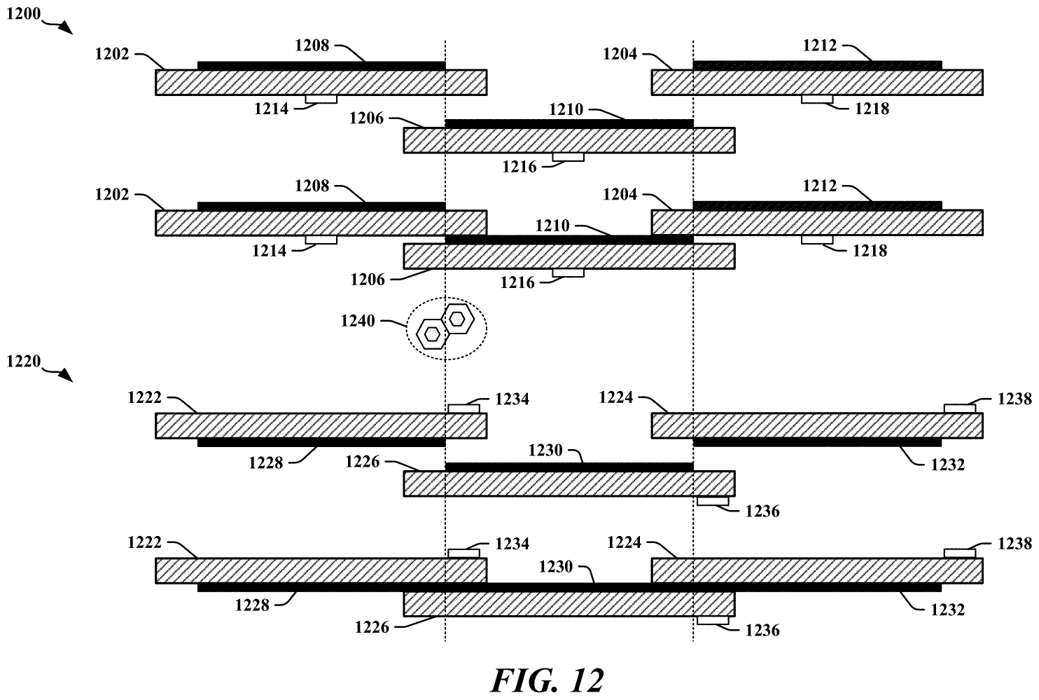

FIG. 12 illustrates examples 1200, 1220 of configurations of PCBs that can be configured to provide of a modular charging surface operated by a wireless charging system that is provided in accordance with certain aspects disclosed herein. The PCBs may correspond to the PCB 1002, 1004 illustrated in FIG. 10. In the first example 1200, each PCB 1202, 1204, 1206 has a transmitter coil section 1208, 1210, 1212 formed in a metal layer on a first surface layer of the PCB 1202, 1204, 1206. In some implementations, the PCBs 1202, 1204, 1206 may have more than two layers. In some implementations, the PCBs 1202, 1204, 1206 may have transmitting coils on both surface layers. In the illustrated example 1200, a processing circuit 1214, 1216, 1218 is provided on the second surface layer. The processing circuit 1214, 1216, 1218 may be configured as a controller that receives and/or directs charging current to one or more transmitter coils. The processing circuit 1214, 1216, 1218 may be provided at any desired or suitable location on the second surface layer. Available locations for the transmitter coil section 1208, 1210, 1212 may be limited based on the location or expected location of electromagnetic flux flows.

In the first example 1200, the PCBs 1202, 1204, 1206 have a common orientation when overlapped during assembly. In one example, the common orientation is provided when each PCB 1202, 1204, 1206 is oriented such that the first surface layer that carries the transmitter coil section 1208, 1210, 1212 is provided as the uppermost layer. In another example, the common orientation is provided when each PCB 1202, 1204, 1206 is oriented such that the first surface layer that carries the transmitter coil section 1228, 1210, 1212 is provided as the lowest layer. The PCBs 1202, 1204, 1206 are overlaid and fastened such that the transmitter coil sections 1208, 1210, 1212 are aligned. In one example, the transmitter coil sections 1208, 1210, 1212 are aligned as illustrated at 1240.

In the second example 1220, each PCB 1222, 1224, 1226 has a transmitter coil section 1228, 1230, 1232 formed in a metal layer on one surface layer of the PCB 1222, 1224, 1226. In some implementations, the PCBs 1222, 1224, 1226 may have more than two layers. In some implementations, the PCBs 1222, 1224, 1226 may have transmitting coils on both surface layers. In the illustrated example 1220, a processing circuit 1234, 1236, 1238 is provided on the second surface layer. The processing circuit 1234, 1236, 1238 may be configured as a controller that receives and/or directs charging current to one or more transmitter coils. The processing circuit 1234, 1236, 1238 may be provided at any desired or suitable location on the second surface layer. Available locations for the transmitter coil section 1228, 1230, 1232 may be limited based on the location or expected location of electromagnetic flux flows. In the illustrated example, the processing circuit 1234, 1236, 1238 is deployed at the edges or corners of the second surface layer.

In the second example 1220, the orientations of the PCBs 1222, 1224, 1226 are alternated when overlapped during assembly. Alternate orientations may be provided when some PCBs 1226 are oriented such that the first surface layer that carries the transmitter coil section 1230 is provided as the uppermost layer and other PCBs 1222, 1224 are oriented such that the first surface layer in which the transmitter coil section 1228, 1232 is the lowest layer. In some instances, the pattern in which transmitting coils are arranged on some PCBs 1226 may be flipped or mirrored with respect to the pattern in which transmitting coils are arranged on the other PCBs 1222, 1224 in order to permit alignment when PCBs 1222, 1224, 1226 with alternated orientation are overlapped. The PCBs 1222, 1224, 1226 are overlaid and fastened such that the transmitter coil sections 1228, 1230, 1232 are aligned. In one example, the transmitter coil sections 1228, 1230, 1232 are aligned as illustrated at 1240.

The configuration illustrated in the second example 1220 can provide transmitter coil sections 1228, 1230, 1232 in a generally planar alignment, which may provide improved consistency and/or uniformity of electromagnetic flux across the modular charging surface.

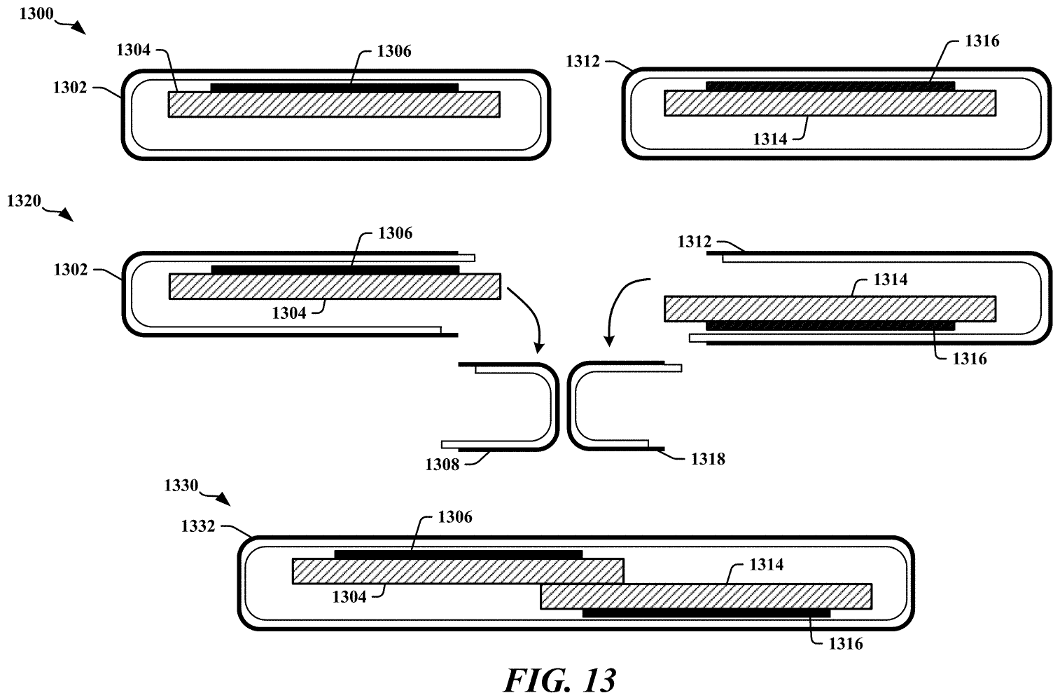

FIG. 13 illustrates a first example of a field-expandable modular charging surface that may be operated as multiple wireless charging devices or as a single wireless charging system in accordance with certain aspects disclosed herein. In an initial configuration 1300, two modular charging surfaces may be operated as standalone units. Each modular charging surface has a PCB 1304, 1314 that may correspond to the PCB 1002, 1004 illustrated in FIG. 10 for example. Each PCB 1304, 1314 has a transmitter coil section formed in a metal layer 1306, 1316 on a first surface layer of the PCB 1304, 1314. In some implementations, the PCBs 1304, 1314 may have more than two layers. In some implementations, the PCBs 1304, 1314 may have transmitting coils on both surface layers. Available locations for the transmitter coil section may be limited to the location or expected location of electromagnetic flux flows. In this example, the modular charging surfaces are provided within a housing 1302, 1312, which has one or more detachable endcaps 1308, 1318, as shown generally in the view 1320.

In some examples, the two modular charging surfaces can be electrically or communicatively coupled to the same controller, enabling the two modular charging surfaces to operate as a distributed charging surface. In some examples, the two modular charging surfaces are electrically or communicatively coupled to individual controllers and operate as two distinct charging devices.

As shown generally at 1330, one of the charging surfaces may be flipped to permit the modular surfaces to be interconnected such that the housings 1302, 1312 form a single larger housing 1332. Processing circuits and connectors are not shown, but can be placed on the PCBs 1304, 1314 in locations that enable multiple PCBs 1304, 1314 to be connected together. When interconnected, the orientation of the PCBs 1304, 1314 are alternated when overlapped during interconnection. The alternate orientation is provided when a first PCB 1304 is oriented such that the surface layer that carries the transmitter coil section is provided as the uppermost layer and another PCB 1314 is oriented such that the surface layer in which the transmitter coil section is the lowest layer. In some instances, the pattern in which transmitting coils are arranged on the PCBs 1304, 1314 is configured to permit alignment when the PCBs 1304, 1314 are overlapped. In one example, the PCBs 1304, 1314 are overlaid and snapped together to obtain mechanical rigidity.

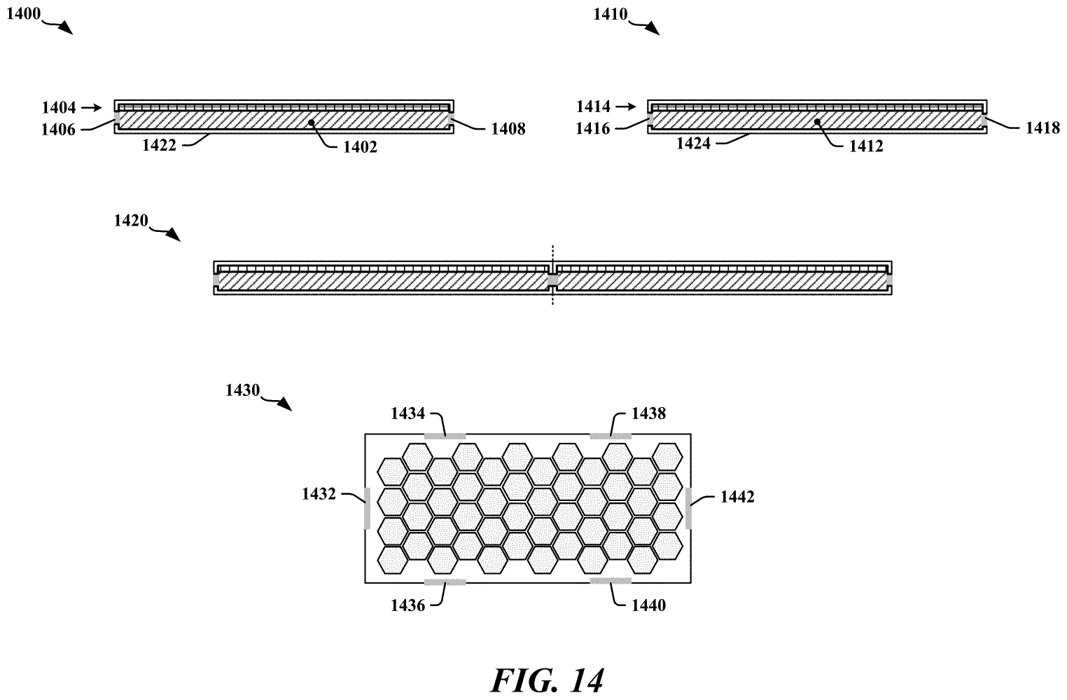

FIG. 14 illustrates a second example of a field-expandable modular charging surface that may be operated as multiple wireless charging devices or as a single wireless charging system in accordance with certain aspects disclosed herein. In an initial configuration, two modular charging devices 1400, 1410 may be operated as standalone units. Each modular charging device 1400, 1410 has a PCB 1402, 1412 that may correspond to the PCB 1002, 1004 illustrated in FIG. 10 for example. Each PCB 1402, 1412 has a transmitter coil section implemented in a metal layer 1404, 1414 on a first surface layer of the PCB 1402, 1412. In some implementations, the PCBs 1402, 1412 may have more than two layers. In some implementations, the PCBs 1402, 1412 may have transmitting coils on both surface layers. Available locations for the transmitter coils in the metal layers 1404, 1414 may be limited to the location or expected location of electromagnetic flux flows. The modular charging surfaces may be provided within a housing and/or conformal coating 1422, 1424 that may be configured or applied to minimize the outer dimensions of the modular charging devices 1400, 1410. The modular charging devices 1400, 1410 may be physically interconnected to obtain a single modular charging system 1420.

The modular charging devices 1400, 1410 may have connectors, magnets, latches and/or other retaining devices or mechanisms 1406, 1408, 1416, 1418 that allow each of the modular charging devices 1400, 1410 to interconnect with one or more other modular charging devices 1400, 1410. In some implementations, the modular charging devices 1400, 1410 can be interconnected end-on-end, and/or side-to-side. In some instances, the modular charging devices 1400, 1410 may be interconnected through the end of one of the modular charging devices 1400, 1410 and through the side of another of the modular charging devices 1400, 1410. As shown generally at 1430, a modular charging device 1400, 1410 may include an interconnector, retaining device or mechanism 1432, 1442 provided at each end, and one or more interconnectors, retaining devices or mechanisms 1434, 1436, 1438, 1440 on a side, where the sides are longer than the ends. The interconnectors, retaining devices or mechanisms 1432, 1434, 1436, 1438, 1440, 1442 may include connectors, connectors, magnets, latches that enable two modular charging devices 1400, 1410 to engage with one another and to be retained in mechanical and electrical coupling. The interconnectors, retaining devices or mechanisms 1432, 1434, 1436, 1438, 1440, 1442 may include a fastening device and/or an electrical interconnect.

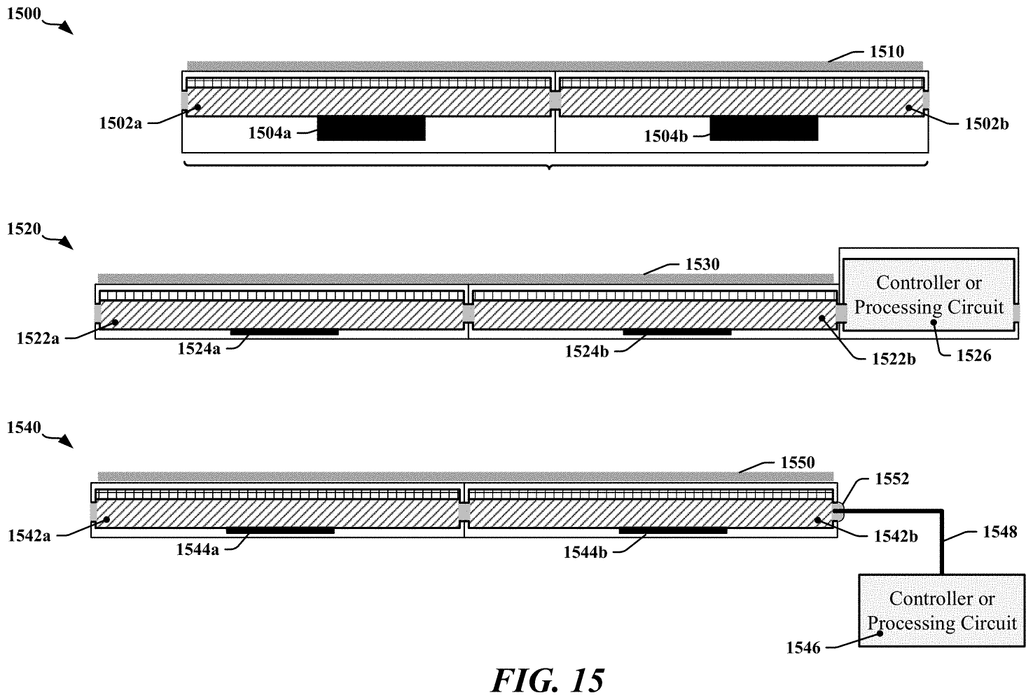

FIG. 15 illustrates examples of configurations of modular charging devices 1500, 1520, 1540 and corresponding control circuits in accordance with certain aspects disclosed herein. In the first configuration, the modular charging device 1500 includes two PCBs 1502a, 1502b that are physically connected and provide a charging surface 1510 that can receive, hold and charge multiple wireless chargeable devices. The modular charging device 1500 may be part of a distributed surface or may be physically connected to other PCBs within a larger modular charging system. Each of the PCBs 1502a, 1502b includes a controller 1504a, 1504b that may include multiple integrated circuit (IC) devices or other discrete electronic components and the controller 1504a, 1504b may be implemented in a processing circuit that is physically tall. In one example, each of the controllers 1504a, 1504b may be configurable to control charging and device detection procedures for multiple PCBs 1502a, 1502b. In some examples, each of the controllers 1504a, 1504b may respond to commands communicated by a primary controller and may be configured to control charging and device detection procedures the corresponding PCB 1502a, 1502b to which it is attached.

In the second configuration, the modular charging device 1520 includes two PCBs 1522a, 1522b that are physically connected to provide a charging surface 1530, which can receive and charge multiple wireless chargeable devices. The modular charging device 1520 may be part of a distributed surface or may be physically connected to other PCBs within a larger modular charging system. Each of the PCBs 1522a, 1522b includes a control circuit 1524a, 1524b that may include discrete components, integrated circuits, such as switches carried on low profile chips or chip carriers. Each of the control circuits 1524a, 1524b may respond to commands communicated by a primary controller 1526 and may be configured to control charging and device detection procedures for the corresponding PCB 1522a or 1522b to which it is attached. In this example, the primary controller 1526 is physically attached to a PCB 1522b that provides at least a portion of an edge of the charging surface 1530. The resulting device may have a thin, low-profile portion corresponding to the charging surface and a raised portion that houses the primary controller 1526 and/or other control circuits.

In the third configuration, the modular charging device 1540 includes two PCBs 1542a, 1542b that are physically connected to provide a charging surface 1550 that can receive and charge multiple wireless chargeable devices. The modular charging device 1540 may be part of a distributed surface or may be physically connected to other PCBs within a larger modular charging system. Each of the PCBs 1542a, 1542b includes a control circuit 1544a, 1544b that may include discrete components, integrated circuits, such as switches carried on low profile chips or chip carriers. Each of the control circuits 1544a, 1544b may respond to commands communicated by a primary controller 1546 and may be configured to control charging and device detection procedures the corresponding PCB 1542a, 1542b to which it is attached. In this example, the primary controller 1546 is electrically coupled to the modular charging device 1540 through an interconnect 1548 and the resulting modular charging device 1540 may be sufficiently thin to present a low profile suitable for incorporation in surfaces of furniture or surfaces in a vehicle. The interconnect 1548 may include a connector 1552 that enables the modular charging device 1540 to be disconnected as needed for service, repair or maintenance.

Certain aspects of this disclosure apply to systems that provide a distributed charging surface that may be implemented using two or more modular charging devices to provide physically distributed charging surface portions that can be operated as a single modular charging surface. From an electrical circuit perspective, the components of the distributed charging surface may be electrically coupled or interconnected in the same manner as that the components of a single charging surface implemented using multiple modular charging devices. From a data communication perspective, the components of the distributed charging surface may be logically coupled or interconnected in the same manner as that the components of a single charging surface implemented using multiple modular charging devices. The physical and electrical characteristics of interconnects may differ between a distributed charging surface and a single charging surface implemented using multiple modular charging devices based on length and impedance of interconnects and other physical characteristics of the interconnects. For the purposes of this description the communication and power distribution architectures may be considered to be identical for a distributed charging surface and for a single charging surface implemented using multiple modular charging devices.

In one example, a primary or main controller may be provided to manage and control charging and/or device discovery procedures in a wireless charging system that includes multiple modular charging devices. In some examples, a controller provided in one of the modular charging devices may be configured to serve as the main controller. In some examples, the main controller may be attached to an edge of a charging surface or provided separately from the modular charging devices. In the latter examples, the separated main controller may enable thin charging surfaces to be attached to or embed in an object of furniture or a surface in a vehicle.

The modular charging devices may include control circuits that can be used to monitor, configure and manage charging operations through the respective charging surfaces provided by the modular charging devices. In some instances, the control circuits may include processing devices or switches that enable the control circuit in a first modular charging device to manage and control charging and/or device discovery in a second modular charging device, including where the second modular charging device is spaced apart or otherwise physically separated from the first modular charging device. The control circuits may control flow of charging currents through access to a power source or by directing the charging current to independent groupings of coils provided on multiple PCBs in interconnected charging devices. The control circuits may be configured to define physically independent charging zones that can be managed and operated as a single system. In one example, the independent charging zones may be provided on a tabletop, shelf, appliance, or other suitable carrier. In another example, the independent charging zones may be deployed in multiple locations within a confined space, such as within a cabin of a car or other vehicle or form of transportation.

A modular or physically-distributed charging surface may be configured to optimize concurrent wireless charging of devices that have a variety of sizes and shapes or that have different sized receiving coils. Concurrent wireless charging of devices may be optimized when a maximum number of devices can be charged simultaneously without compromising speed of charging devices associated with high power consumption. In one example, a wireless charging system may be expected to charge a tablet computer and multiple smaller devices such as a smartwatch or mobile telephone. Optimal charging of the tablet computer may necessitate the use of a large transmitting coil, while smaller transmitting coils may facilitate stacking of physically smaller devices or devices associated with low power consumption by providing a larger number of charging cells within an area of the charging surface.

In one aspect of the disclosure, a mixture of modular or physically-distributed charging surfaces can be connected or coupled to provide different charging zones with different charging cell sizes. In another aspect of the disclosure, certain modular or physically-distributed charging surfaces can include different charging zones with different charging cell sizes. In another aspect of the disclosure, a standalone charging surface can include different charging zones with different charging cell sizes.

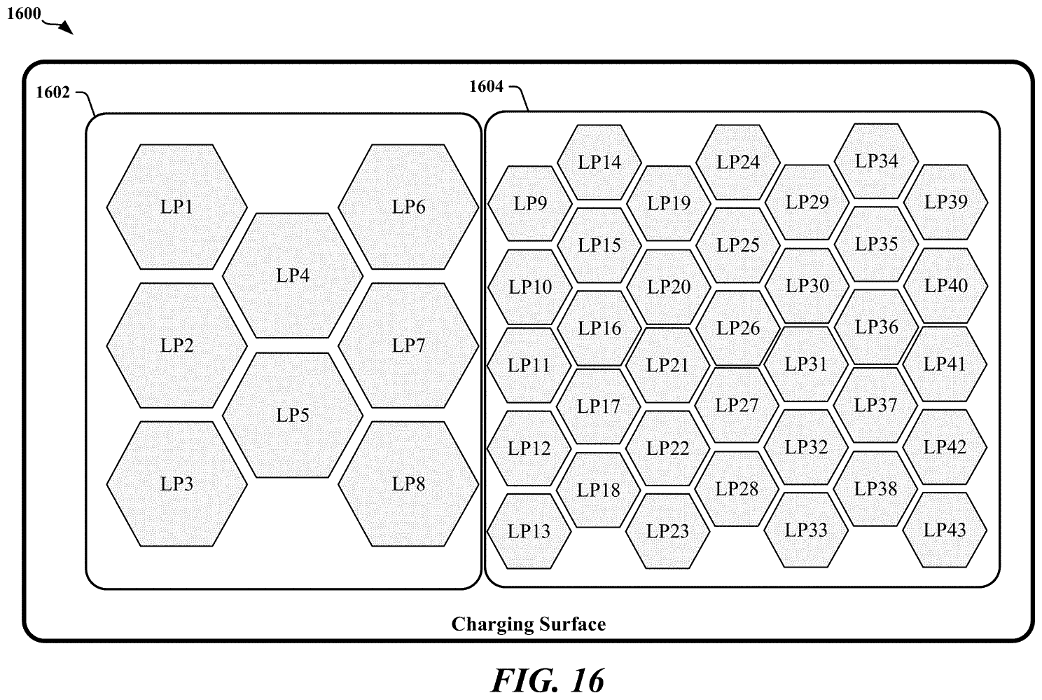

FIG. 16 illustrates an example of a modular or physically-distributed charging surface 1600 that includes two charging zones 1602, 1604 that have charging cells of different sizes. The first charging zone 1602 includes larger charging cells that may be suited for high-power wireless transfers. In one example, multi-coil transmitting cells in the first charging zone 1602 may be configured to transfer power up to 30 W. The second charging zone 1604 includes smaller charging cells that may be suited for lower-power wireless transfers. In one example, transmitting cells in the second charging zone 1604 may be configured to wirelessly transfer power at 5-10 W.

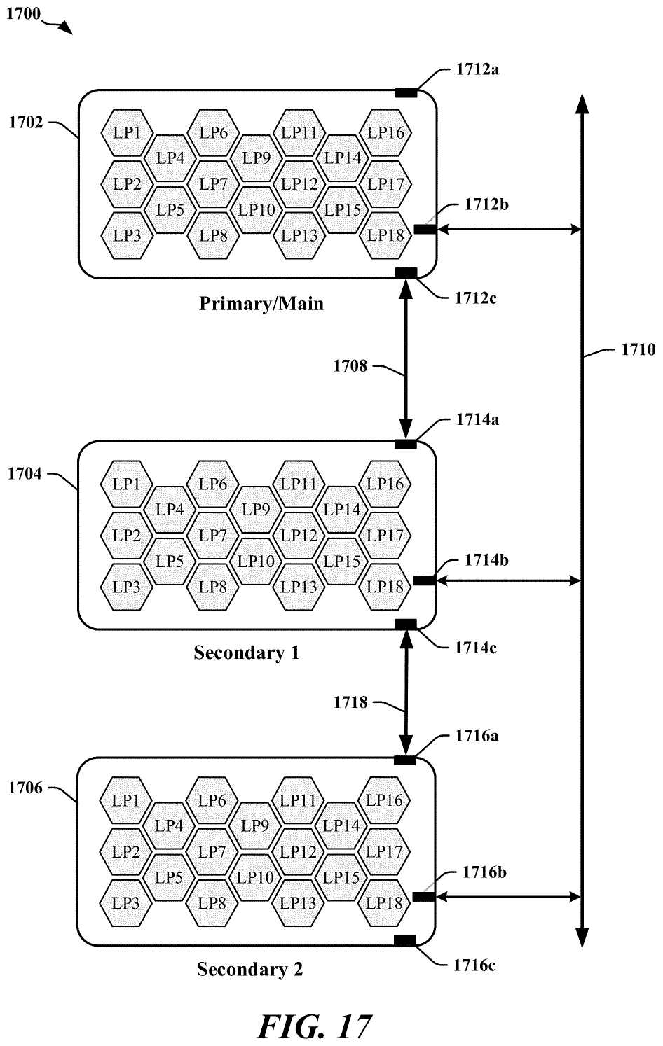

FIG. 17 illustrates an example of a charging system 1700 that includes multiple charging devices 1702, 1704, 1706 provided in accordance with certain aspects of this disclosure. In one example, the charging devices 1702, 1704, 1706 may be physically joined or interconnected to provide a single scalable, modular charging surface such as the modular charging surfaces illustrated in FIGS. 9-11. In some examples, one or more of the charging devices 1702, 1704, 1706 may be remotely located from at least one other charging device 1702, 1704, 1706 to provide a distributed charging surface. The charging system 1700 may include one or more controllers that can communicate with the charging devices 1702, 1704, 1706. In one example, a primary controller may communicate control messages to a secondary controller over a data communication link. In some examples, a primary controller may provide control signals that are used to control charging or detection operations at the charging devices 1702, 1704, 1706. In some examples, the primary controller may control power flow in the charging devices 1702, 1704, 1706. In some examples, the primary controller may provide charging currents to one or more groups of charging coils on the charging devices 1702, 1704, 1706.

Each charging device 1702, 1704, 1706 may include one or more charging cells that encompass one or more power transfer areas. Each power transfer area is substantially planar and centered around an axis that is substantially perpendicular to its a charging surface of its associated charging device 1702, 1704, 1706. In some examples, each of the charging devices 1702, 1704, 1706 can operate as a standalone wireless charger that includes controllers and power management circuits. The standalone wireless charger may be configured to detect chargeable devices, generate charging configurations and provide a charging current to one or more charging cells identified by the charging configurations.

In some examples, certain charging devices 1704, 1706 operate as secondary devices that have limited capability. In one example, the limited-capability charging devices 1704, 1706 receive charging currents through dedicated connectors and the charging currents are directed to one or more charging cells through fixed electrical paths or through a switch that may be controlled by a primary charging device 1704 or other centralized or distributed controller. In another example, the limited-capability charging devices 1704, 1706 may have a controller capable of selecting charging cells to receive a charging current and to provide the charging current to the selected charging cells. In the latter example, some limited-capability charging devices 1704, 1706 may be configured to exchange messages with one or more other charging devices 1702, 1704, 1706 in the system, or exchange messages with a chargeable device. In some instances, the limited-capability charging devices 1704, 1706 may be capable of conducting searches for chargeable devices or may be configured to participate in a search for chargeable devices controlled by a primary charging device 1704 or other centralized or distributed controller.

The charging system 1700 is constructed from interconnected charging devices 1702, 1704, 1706. The charging devices 1702, 1704, 1706 may have a same or different size or shape. The charging devices 1702, 1704, 1706 may have a same or different number or configuration of power transmitting coils. In the illustrated example, the charging devices 1702, 1704, 1706 have similar size, shape and transmitting coil configuration, although the charging devices 1702, 1704, 1706 have a same or different configuration in other implementations. The charging devices 1702, 1704, 1706 may correspond to the charging devices illustrated in FIGS. 8-15 or may provide similar configurations of charging surfaces illustrated in the charging devices of FIGS. 8-15.

In certain examples, each of the charging devices 1702, 1704, 1706 includes one or more connectors 1712a, 1712b, 1712c, 1714a 1714b, 1714c, 1716a 1716b, 1716c, which may couple the charging devices 1702, 1704, 1706 to a multi-drop serial bus 1710 or support a daisy chain connection 1708, 1718. In one example, the multi-drop serial bus 1710 is configured as a serial bus that enables the charging devices 1702, 1704, 1706 to exchange command and control messages. In one example, the serial bus is operated in accordance with Improved Inter-Integrated Circuit (I3C) protocols, Controller Area Network (CAN) bus protocols, Local Interconnected Network (LIN) bus protocols, or the like. In some instances, the charging devices 1702, 1704, 1706 may communicate wirelessly. In some implementations, the daisy chain connection 1708, 1718 is used to distribute charging current among the charging devices 1702, 1704, 1706. The daisy chain connection 1708, 1718 may also be used for exchanging command and control messages.

In one example, one or more of the charging devices 1702, 1704, 1706 can serve as a primary device and may include a processing circuit configured to manage operation of one or more charging devices 1702, 1704, 1706 that is operated as a secondary device. In the illustrated example, two charging devices 1704, 1706 operate as secondary devices and may include processing circuits configured to communicate over the multi-drop serial bus 1710 in order to receive commands from the primary charging device 1702 and to report feedback information to the primary charging device 1702. Secondary charging devices 1702, 1704, 1706 may include or control a driver circuit that provides a flow of a charging current provided through the daisy chain connection 1708, 1718, when the charging current is provided by a current source through the operation of the primary charging device 1702.

The secondary charging devices 1704, 1706 may cooperate with the primary charging device 1702 to discover, enumerate and configure the combination of charging devices 1702, 1704, 1706 provided in the charging system 1700. In one example, the secondary charging devices 1704, 1706 participate in a serial bus arbitration process to identify themselves to the primary charging device 1702 and/or to obtain unique addresses. In another example, the secondary charging devices 1704, 1706 may be preconfigured with at least a secondary address that the primary charging device 1702 can use to address each secondary charging device 1704, 1706 through the multi-drop serial bus 1710. The primary charging device 1702 may use the multi-drop serial bus 1710 to configure the secondary charging devices 1704, 1706, interrogate the secondary charging devices 1704, 1706 for capability, charging cell size, number and configuration as well as status information. The primary charging device 1702 may use the multi-drop serial bus 1710 to configure the secondary charging devices 1704, 1706 for one or more charging operations.

In some implementations, each of the charging devices 1702, 1704, 1706 can be independently connected to a power supply that can be used to provide and configure a charging current. In one example, the charging devices 1702, 1704, 1706 may include an inverter or switching power supply configurable to produce an alternating current (AC) that has frequency suitable for wireless charging. In some implementations, each of the charging devices 1702, 1704, 1706 may be coupled to a multi-purpose communication bus that is used by other devices or systems (in an automobile for example). In the latter implementations, the primary charging device 1702 may also be a controlling entity on the bus.

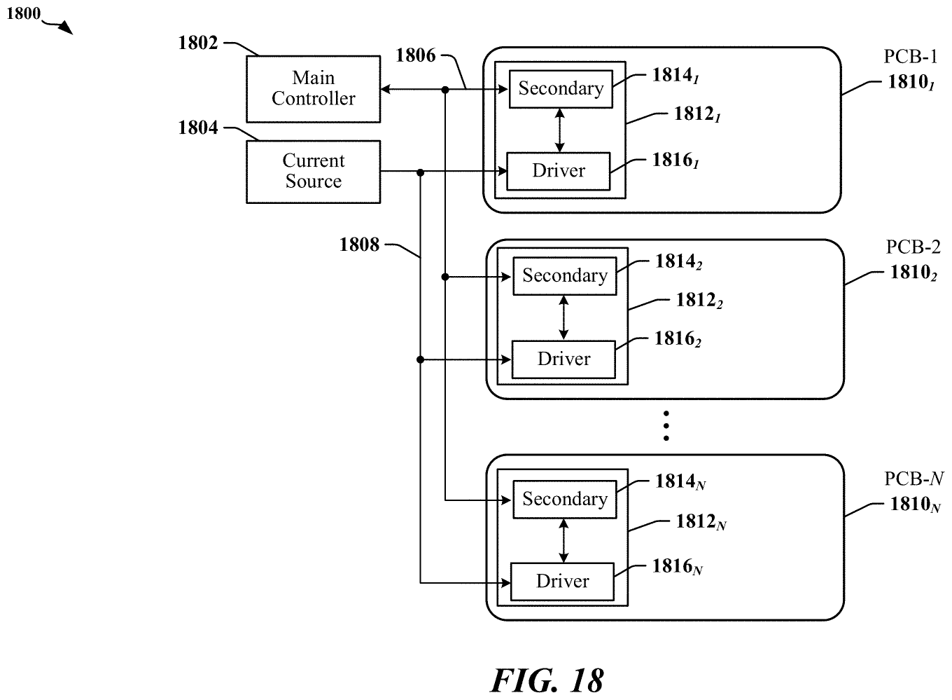

FIG. 18 illustrates a first example of a combined control circuit 1800 in a charging system provided in accordance with certain aspects disclosed herein. Each PCB 1810₁-1812_{N} includes a processing circuit 1812₁-1812_{N} that is configured and controlled by a main controller 1802 to manage operation of its respective PCB 1810₁-1812_{N}. In one example, each processing circuit 1812₁-1812_{N} includes a secondary circuit 1814₁-1814_{N} configured to communicate over a serial bus 1806 in order to receive commands and report feedback information to the main controller 1802. The secondary circuit 1814₁-1814_{N} may control a driver circuit 1816₁-1816_{N} that controls flow of a charging current provided through an interlink 1808 by a current source.

The secondary circuits 1814₁-1814_{N} may cooperate with the main controller 1802 to discover, enumerate and configure the combination of PCBs 1810₁-1812_{N} provided in the modular charging surface. In one example, the secondary circuits 1814₁-1814_{N} participate in an arbitration process to identify themselves to the main controller 1802 and/or to obtain unique addresses. In another example, the secondary circuits 1814₁-1814_{N} may be preconfigured with at least a secondary address that the main controller 1802 can use to address each secondary circuit 1814₁-1814_{N} through the serial bus 1806. The main controller 1802 may use the serial bus 1806 to configure the secondary circuits 1814₁-1814_{N}, interrogate the secondary circuits 1814₁-1814_{N} for capability and status information, and configure the secondary circuits 1814₁-1814_{N} for one or more charging operations.

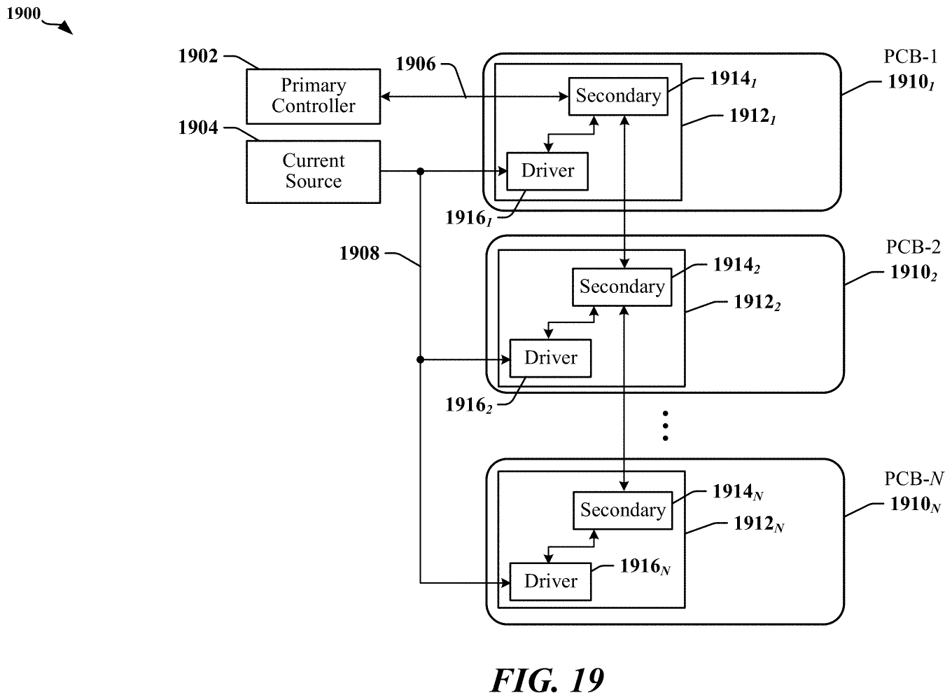

FIG. 19 illustrates a second example of a combined control circuit 1900 that may be provided in a charging system provided in accordance with certain aspects disclosed herein. Each PCB 1910₁-1912_{N} includes a processing circuit 1912₁-1912_{N} that is configured and controlled by a main controller 1902 to manage operation of its respective PCB 1910₁-1912_{N}. In one example, each processing circuit 1912₁-1912_{N} includes a secondary circuit 1914₁-1914_{N} configured to communicate over a serial bus 1906 in order to receive commands and report feedback information to the main controller 1902. The secondary circuit 1914₁-1914_{N} may control a driver circuit 1916₁-1916_{N} that controls flow of a charging current provided through an interlink 1908 by a current source.

The secondary circuits 1914₁-1914_{N} may cooperate with the main controller 1902 to discover, enumerate and configure the combination of PCBs 1910₁-1912_{N} provided in the modular charging surface. In the illustrated example, the secondary circuits 1914i-1914_{N} are connected in a daisy chain fashion, whereby the main controller 1902 connects with and configures a first secondary circuit 1914i, which then couples the second secondary circuit 19142 to the main controller 1902 through the serial bus 1906. The main controller 1902 configures the second secondary circuit 19142 and the process continues until the last secondary circuit 1914_{N} has been configured. In another example, the secondary circuits 1914₁-1914_{N} may be preconfigured with at least a secondary address that the main controller 1902 can use to address each secondary circuit 1914₁-1914_{N} through the serial bus 1906.

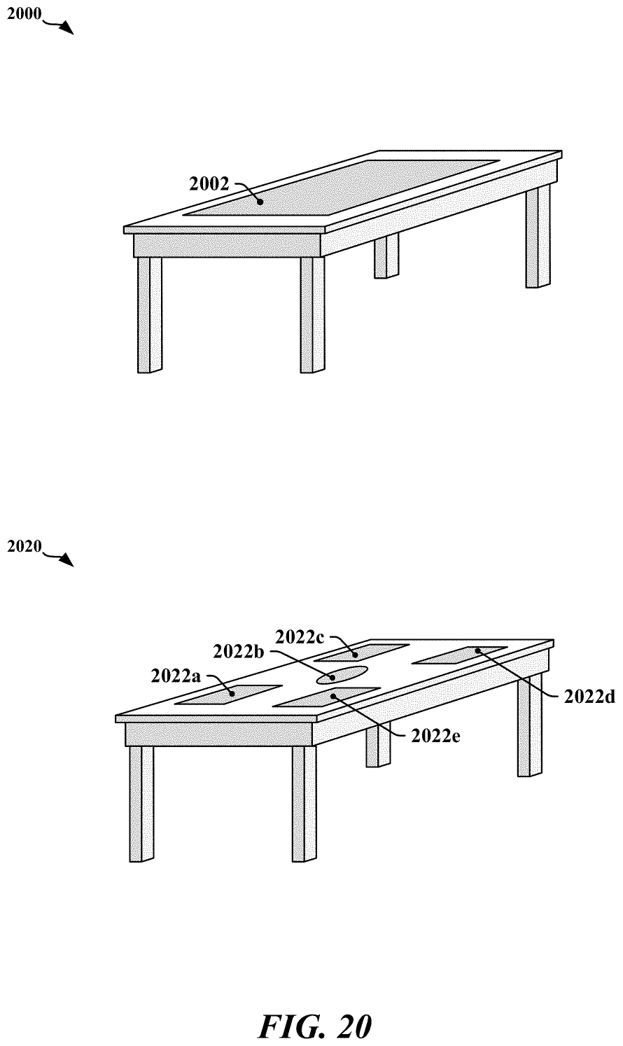

FIG. 20 illustrates the use of modular charging devices to provide one or more charging surfaces on an item of furniture in accordance with certain aspects of this disclosure. The item of furniture is selected for clarity and ease of illustration. Modular charging devices may be provided in other items including armrests of armchair, armrests in an automobile, windowsills in a room, consoles in a vehicle, tray tables in an airplane and other examples. A first table 2000 is equipped with a large charging surface 2002 that may be assembled from numerous charging modules that are arranged and configured to provide the large charging surface 2002. A second table 2020 is equipped with a multiple charging surfaces 2022a-2022e that can have different sizes or shapes. Each of the charging surfaces 2022a-2022e may be implemented using one or more charging modules constructed in accordance with the examples illustrated in FIGS. 8-17. In some examples, at least one of the charging modules may differ from other charging modules by overall size or shape or by the number, size or configuration of included charging coils.

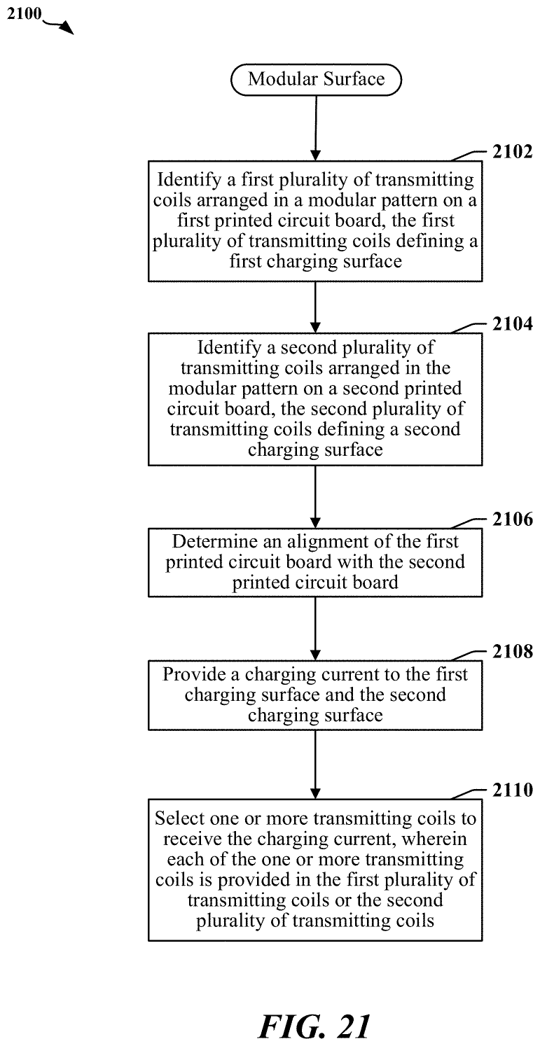

FIG. 21 is flowchart 2100 illustrating one example of a method for operating a charging system. The method may be performed by a processor in a main or primary controller 1504a, 1504b, 1526, 1546, 1802 or 1902. At block 2102, the processor may identify a first plurality of transmitting coils arranged in a pattern on a surface of a first charging device thereby defining a first charging surface. At block 2104, the processor may identify a second plurality of transmitting coils arranged in the pattern on a surface of a second charging device, the second plurality of transmitting coils defining a second charging surface. At block 2106, the processor may establish communication between the first charging device and the second charging device through a communication bus. At block 2108, the processor may provide charging currents to the first charging surface and the second charging surface. At block 2110, the processor may select one or more transmitting coils to receive the charging current. Each of the one or more transmitting coils may be provided in the first plurality of transmitting coils or the second plurality of transmitting coils. In some examples, the first charging device and the second charging device are physically separated.

In certain implementations, the processor is configured to transmit a command from the first charging device to the second charging device. The command may be configured to cause the controller to direct the charging current to the one or more transmitting coils selected to receive the charging current. The processor may receive configuration information at the first charging device from the second charging device. The processor may cause the receive status from the second charging device.

In some examples, the processor may establish communication through the communication bus with a controller provided in a third charging device. The processor may configure a charging configuration for a receiving device and may identify the one or more transmitting coils selected to receive the charging current based on the charging configuration. In some examples, the processor may transmit a command from the first charging device to the second charging device. The command may be configured to cause the second charging device to direct the charging current to the one or more transmitting coils selected to receive the charging current.

### Example of a Processing Circuit

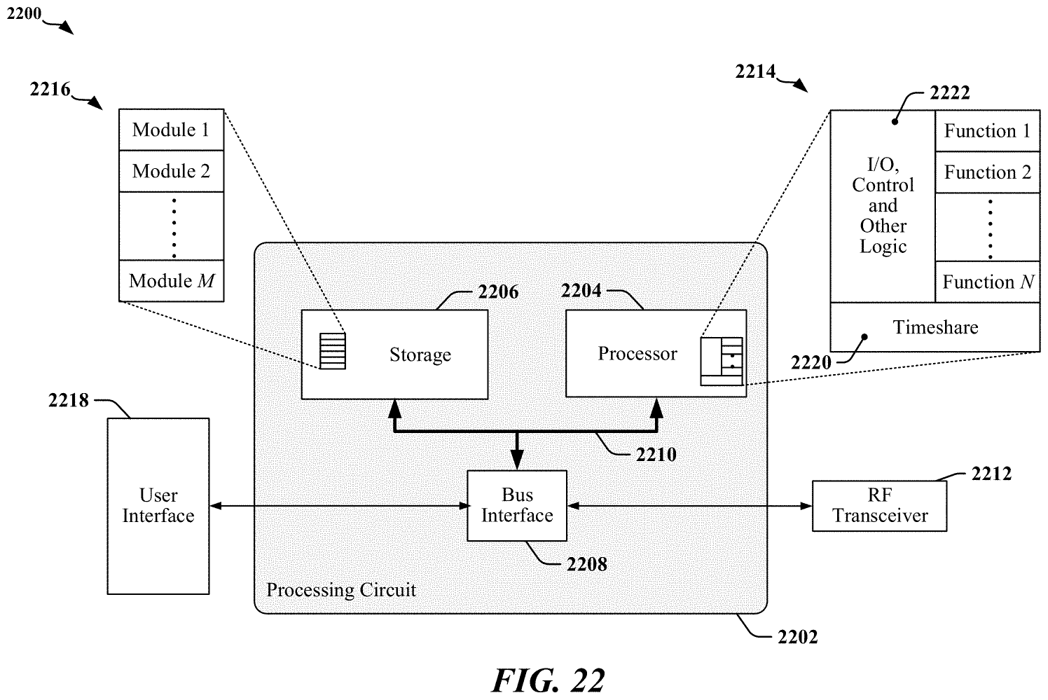

FIG. 22 is a diagram illustrating an example of a hardware implementation for an apparatus 2200 that may be incorporated in a charging device or in a receiving device that enables a battery to be wirelessly charged. In some examples, the apparatus 2200 may perform one or more functions disclosed herein. In accordance with various aspects of the disclosure, an element, or any portion of an element, or any combination of elements as disclosed herein may be implemented using a processing circuit 2202. The processing circuit 2202 may include one or more processors 2204 that are controlled by some combination of hardware and software modules. Examples of processors 2204 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 2204 may include specialized processors that perform specific functions, and that may be configured, augmented or controlled by one of the software modules 2216. The one or more processors 2204 may be configured through a combination of software modules 2216 loaded during initialization, and further configured by loading or unloading one or more software modules 2216 during operation.

In the illustrated example, the processing circuit 2202 may be implemented with a bus architecture, represented generally by the bus 2210. The bus 2210 may include any number of interconnecting buses and bridges depending on the specific application of the processing circuit 2202 and the overall design constraints. The bus 2210 links together various circuits including the one or more processors 2204, and storage 2206. Storage 2206 may include memory devices and mass storage devices, and may be referred to herein as computer-readable media and/or processor-readable media. The storage 2206 may include transitory storage media and/or non-transitory storage media.

The bus 2210 may also link various other circuits such as timing sources, timers, peripherals, voltage regulators, and power management circuits. A bus interface 2208 may provide an interface between the bus 2210 and one or more transceivers 2212. In one example, a transceiver 2212 may be provided to enable the apparatus 2200 to communicate with a charging or receiving device in accordance with a standards-defined protocol. Depending upon the nature of the apparatus 2200, a user interface 2218 (e.g., keypad, display, speaker, microphone, joystick) may also be provided, and may be communicatively coupled to the bus 2210 directly or through the bus interface 2208.

A processor 2204 may be responsible for managing the bus 2210 and for general processing that may include the execution of software stored in a computer-readable medium that may include the storage 2206. In this respect, the processing circuit 2202, including the processor 2204, may be used to implement any of the methods, functions and techniques disclosed herein. The storage 2206 may be used for storing data that is manipulated by the processor 2204 when executing software, and the software may be configured to implement any one of the methods disclosed herein.

One or more processors 2204 in the processing circuit 2202 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 2206 or in an external computer-readable medium. The external computer-readable medium and/or storage 2206 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 2206 may also include, by way of example, a carrier wave, a transmission line, and any other suitable medium for transmitting software and/or instructions that may be accessed and read by a computer. Computer-readable medium and/or the storage 2206 may reside in the processing circuit 2202, in the processor 2204, external to the processing circuit 2202, or be distributed across multiple entities including the processing circuit 2202. The computer-readable medium and/or storage 2206 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 2206 may maintain software maintained and/or organized in loadable code segments, modules, applications, programs, etc., which may be referred to herein as software modules 2216. Each of the software modules 2216 may include instructions and data that, when installed or loaded on the processing circuit 2202 and executed by the one or more processors 2204, contribute to a run-time image 2214 that controls the operation of the one or more processors 2204. When executed, certain instructions may cause the processing circuit 2202 to perform functions in accordance with certain methods, algorithms and processes described herein.

Some of the software modules 2216 may be loaded during initialization of the processing circuit 2202, and these software modules 2216 may configure the processing circuit 2202 to enable performance of the various functions disclosed herein. For example, some software modules 2216 may configure internal devices and/or logic circuits 2222 of the processor 2204, and may manage access to external devices such as a transceiver 2212, the bus interface 2208, the user interface 2218, timers, mathematical coprocessors, and so on. The software modules 2216 may include a control program and/or an operating system that interacts with interrupt handlers and device drivers, and that controls access to various resources provided by the processing circuit 2202. The resources may include memory, processing time, access to a transceiver 2212, the user interface 2218, and so on.

One or more processors 2204 of the processing circuit 2202 may be multifunctional, whereby some of the software modules 2216 are loaded and configured to perform different functions or different instances of the same function. The one or more processors 2204 may additionally be adapted to manage background tasks initiated in response to inputs from the user interface 2218, the transceiver 2212, and device drivers, for example. To support the performance of multiple functions, the one or more processors 2204 may be configured to provide a multitasking environment, whereby each of a plurality of functions is implemented as a set of tasks serviced by the one or more processors 2204 as needed or desired. In one example, the multitasking environment may be implemented using a timesharing program 2220 that passes control of a processor 2204 between different tasks, whereby each task returns control of the one or more processors 2204 to the timesharing program 2220 upon completion of any outstanding operations and/or in response to an input such as an interrupt. When a task has control of the one or more processors 2204, the processing circuit is effectively specialized for the purposes addressed by the function associated with the controlling task. The timesharing program 2220 may include an operating system, a main loop that transfers control on a round-robin basis, a function that allocates control of the one or more processors 2204 in accordance with a prioritization of the functions, and/or an interrupt driven main loop that responds to external events by providing control of the one or more processors 2204 to a handling function.

In some examples, the apparatus 2200 includes, or operates as a wireless charging system that has a battery charging power source coupled to a charging circuit, a plurality of charging cells and one or more processors 2204. The plurality of charging cells may be configured to provide a modular charging surface. At least one coil may be configured to direct an electromagnetic field through a charge transfer area of each charging cell. The modular charging surface may be configured using a first plurality of transmitting coils arranged in a modular pattern on a first printed circuit board, the first plurality of transmitting coils defining a first charging surface, and a second plurality of transmitting coils arranged in the modular pattern on a second printed circuit board, the second plurality of transmitting coils defining a second charging surface. A fastening device may be configured to fasten the first printed circuit board in alignment with the second printed circuit board such that the modular pattern is continued from the first charging surface into the second charging surface. An electrical interconnect may be configured to conduct a charging current from the first charging surface into the second charging surface. The one or more processors 2204 may be configured to select one or more transmitting coils to receive the charging current. Each of the one or more transmitting coils may be provided in the first plurality of transmitting coils or the second plurality of transmitting coils.

In one example, the first printed circuit board is in alignment with the second printed circuit board when an edge of the modular pattern on the first printed circuit board is in planar alignment with an edge of the modular pattern on the second printed circuit board. The first printed circuit board and the second printed circuit board may be oriented such that the first plurality of transmitting coils is provided on an upper surface of the first printed circuit board and the second plurality of transmitting coils is provided on a lower surface of the second printed circuit board.

In certain implementations, the first printed circuit board has a controller configured to receive a command from the processor and, responsive to the command, direct the charging current to the one or more transmitting coils selected to receive the charging current by the processor. The controller may be configured to report status or configuration information to the one or more processors 2204. The controller may be configured to establish communication with a corresponding controller provided on the second printed circuit board. The one or more processors 2204 may be adapted to configure a charging configuration for a receiving device, and identify the one or more transmitting coils selected to receive the charging current based on the charging configuration. The fastening device may be a screw or involve bonding.

In some implementations, the storage 2206 maintains instructions and information where the instructions are configured to cause the one or more processors 2204 to identify a first plurality of transmitting coils arranged in a modular pattern on a first printed circuit board, the first plurality of transmitting coils defining a first charging surface, identify a second plurality of transmitting coils arranged in the modular pattern on a second printed circuit board, the second plurality of transmitting coils defining a second charging surface, determine an alignment of the first printed circuit board with the second printed circuit board, provide a charging current to the first charging surface and the second charging surface, and select one or more transmitting coils to receive the charging current. Each of the one or more transmitting coils may be provided in the first plurality of transmitting coils or the second plurality of transmitting coils.

In one example, an edge of the modular pattern on the first printed circuit board is in planar alignment with an edge of the modular pattern on the second printed circuit board. The first printed circuit board and the second printed circuit board may be oriented such that the first plurality of transmitting coils is provided on an upper surface of the first printed circuit board and the second plurality of transmitting coils is provided on a lower surface of the second printed circuit board.

In certain implementations, the instructions are configured to cause the one or more processors 2204 to transmit a command to a controller provided on the first printed circuit board. The command may be configured to cause the controller to direct the charging current to the one or more transmitting coils selected to receive the charging current by the processor. The instructions may be configured to cause the one or more processors 2204 to receive status or configuration information from the controller. The instructions may be configured to cause the one or more processors 2204 to may receive status from the controller. The instructions may be configured to cause the one or more processors 2204 to establish communication with controllers provided on the first printed circuit board and the second printed circuit board. The instructions may be configured to cause the one or more processors 2204 to may configure a charging configuration for a receiving device, and identify the one or more transmitting coils selected to receive the charging current based on the charging configuration.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A charging device, comprising:
a first plurality of transmitting coils arranged in a modular pattern on a first printed circuit board, the first plurality of transmitting coils defining a first charging surface;
a second plurality of transmitting coils arranged in the modular pattern on a second printed circuit board, the second plurality of transmitting coils defining a second charging surface;
a fastening device configured to fasten the first printed circuit board in alignment with the second printed circuit board such that the modular pattern is continued from the first charging surface into the second charging surface;
an electrical interconnect configured to conduct a charging current from the first charging surface into the second charging surface; and
and a processor configured to select one or more transmitting coils to receive the charging current, wherein each of the one or more transmitting coils is provided in the first plurality of transmitting coils or the second plurality of transmitting coils.

2. The charging device of claim 1, wherein the first printed circuit board is in alignment with the second printed circuit board when an edge of the modular pattern on the first printed circuit board is in planar alignment with an edge of the modular pattern on the second printed circuit board.

3. The charging device of claim 1, wherein the first printed circuit board and the second printed circuit board are oriented such that the first plurality of transmitting coils is provided on an upper surface of the first printed circuit board and the second plurality of transmitting coils is provided on a lower surface of the second printed circuit board.

4. The charging device of claim 1, wherein the first printed circuit board comprises a controller configured to:
receive a command from the processor; and
responsive to the command, direct the charging current to the one or more transmitting coils selected to receive the charging current by the processor.

5. The charging device of claim 4, wherein the controller is further configured to:
report configuration information to the processor.

6. The charging device of claim 4, wherein the controller is further configured to:
transmit status to the processor.

7. The charging device of claim 4, wherein the controller is further configured to:
establish communication with a corresponding controller provided on the second printed circuit board.

8. The charging device of claim 1, wherein the processor is further configured to:
configure a charging configuration for a receiving device; and
identify the one or more transmitting coils selected to receive the charging current based on the charging configuration.

9. The charging device of claim 1, wherein the fastening device comprises a screw.

10. The charging device of claim 1, wherein the fastening device comprises a bond.

11. A method for configuring a charging device, comprising:
identifying a first plurality of transmitting coils arranged in a modular pattern on a first printed circuit board, the first plurality of transmitting coils defining a first charging surface;
identifying a second plurality of transmitting coils arranged in the modular pattern on a second printed circuit board, the second plurality of transmitting coils defining a second charging surface;
determining an alignment of the first printed circuit board with the second printed circuit board;
providing a charging current to the first charging surface and the second charging surface; and
selecting one or more transmitting coils to receive the charging current, wherein each of the one or more transmitting coils is provided in the first plurality of transmitting coils or the second plurality of transmitting coils.

12. The method of claim 11, wherein an edge of the modular pattern on the first printed circuit board is in planar alignment with an edge of the modular pattern on the second printed circuit board.

13. The method of claim 11, wherein the first printed circuit board and the second printed circuit board are oriented such that the first plurality of transmitting coils is provided on an upper surface of the first printed circuit board and the second plurality of transmitting coils is provided on a lower surface of the second printed circuit board.

14. The method of claim 11, further comprising:
transmitting a command to a controller provided on the first printed circuit board, the command configured to cause the controller to direct the charging current to the one or more transmitting coils selected to receive the charging current.

15. The method of claim 14, further comprising:
receiving configuration information from the controller.

16. The method of claim 14, further comprising:
receiving status from the controller.

17. The method of claim 11, further comprising:
establishing communication with controllers provided on the first printed circuit board and the second printed circuit board.

18. The method of claim 11, further comprising:
configuring a charging configuration for a receiving device; and
identifying the one or more transmitting coils selected to receive the charging current based on the charging configuration.

19. A processor-readable storage medium having instructions stored thereon which, when executed by at least one processor, cause the at least one processor to:
identify a first plurality of transmitting coils arranged in a modular pattern on a first printed circuit board, the first plurality of transmitting coils defining a first charging surface;
identify a second plurality of transmitting coils arranged in the modular pattern on a second printed circuit board, the second plurality of transmitting coils defining a second charging surface;
determine an alignment of the first printed circuit board with the second printed circuit board;
provide a charging current to the first charging surface and the second charging surface; and
select one or more transmitting coils to receive the charging current, wherein each of the one or more transmitting coils is provided in the first plurality of transmitting coils or the second plurality of transmitting coils.
